(19) United States
(12) Patent Application Publication
(10) Pub. No.: US 2023/0209551 A1
(43) Pub. Date: Jun. 29, 2023

(54) RESOURCE DETERMINING METHOD AND APPARATUS, TERMINAL, AND NETWORK SIDE DEVICE

(71) Applicant: VIVO MOBILE COMMUNICATION CO., LTD., Dongguan (CN)

(72) Inventors: Siqi LIU, Dongguan (CN); Zichao JI, Dongguan (CN)

(73) Assignee: VIVO MOBILE COMMUNICATION CO., LTD., Dongguan (CN)

(21) Appl. No.: 18/118,119

(22) Filed: Mar. 6, 2023

Related U.S. Application Data
(63) Continuation of application No. PCT/CN2021/116928, filed on Sep. 7, 2021.

(30) Foreign Application Priority Data
Sep. 7, 2020 (CN) 202010931453.1

(51) Int. Cl. H04W 72/20; H04W 72/23

(52) U.S. Cl. CPC H04W 72/20; H04W 72/23

(57) ABSTRACT

A resource determining method and apparatus, a terminal, and a network side device are provided. The method includes: determining a control resource corresponding to first control signaling according to a target identifier, where the control resource includes at least one of a monitoring occasion, a candidate control channel, a candidate control signal, or a control channel element; and the first control signaling is used to schedule at least one target object, and the target object is a sidelink (SL) carrier, an SL cell, an SL resource pool, or an SL bandwidth part (BWP).

### CROSS-REFERENCE TO RELATED APPLICATIONS

This application is a continuation of International Application No. PCT/CN2021/116928, filed Sep. 7, 2021, which claims priority to Chinese Patent Application No. 202010931453.1, filed Sep. 7, 2020. The entire contents of each of the above-referenced applications are expressly incorporated herein by references.

### TECHNICAL FIELD

This application pertains to the field of communications technologies, and specifically relates to a resource determining method and apparatus, a terminal, and a network side device.

### BACKGROUND

In a mobile communications system, for example, a fifth-generation (5G) New Radio (NR) system, carrier aggregation (CA) is supported, a plurality of component carrier (CC) or cells may be configured and activated for User Equipment (UE), and cross-carrier scheduling in CA is supported. In addition, a base station may further schedule an SL resource by using Sidelink (SL) DCI. A formula for calculating a candidate PDCCH search space is related to a CIF corresponding to a Uu cell scheduled by using DCI carried in the search space.

A control resource for scheduling a Uu cell is related to a CIF corresponding to the cell, but a scheduled SL carrier may not be defined as one Uu cell or a plurality of associated Uu cells on an SL dedicated band. Therefore, it cannot be determined a control resource in which SL DCI is located.

### SUMMARY

Embodiments of this application provide a resource determining method and apparatus, and a terminal.

According to a first aspect, an embodiment of this application provides a resource determining method. The method is performed by a terminal and includes:

determining a control resource corresponding to first control signaling according to a target identifier, where the control resource includes at least one of a monitoring occasion, a candidate control channel, a candidate control signal, or a control channel element; and

the first control signaling is used to schedule at least one target object, and the target object is a sidelink SL carrier, an SL cell, an SL resource pool, or an SL bandwidth part BWP.

According to a second aspect, an embodiment of this application provides a resource determining method. The method is performed by a network side device and includes:

determining a control resource corresponding to first control signaling according to a target identifier, where the control resource includes at least one of a monitoring occasion, a candidate control channel, a candidate control signal, or a control channel element; and

the first control signaling is used to schedule at least one target object, and the target object is a sidelink SL carrier, an SL cell, an SL resource pool, or an SL bandwidth part BWP.

According to a third aspect, an embodiment of this application provides a resource determining apparatus. The apparatus is performed by a terminal and includes:

a first determining module, configured to determine a control resource corresponding to first control signaling according to a target identifier, where the control resource includes at least one of a monitoring occasion, a candidate control channel, a candidate control signal, or a control channel element; and

the first control signaling is used to schedule at least one target object, and the target object is a sidelink SL carrier, an SL cell, an SL resource pool, or an SL bandwidth part BWP.

According to a fourth aspect, an embodiment of this application provides a resource determining apparatus. The apparatus is performed by a network side device and includes:

a third determining module, configured to determine a control resource corresponding to first control signaling according to a target identifier, where the control resource includes at least one of a monitoring occasion, a candidate control channel, a candidate control signal, or a control channel element; and

the first control signaling is used to schedule at least one target object, and the target object is a sidelink SL carrier, an SL cell, an SL resource pool, or an SL bandwidth part BWP.

According to a fifth aspect, an embodiment of this application provides a terminal. The terminal includes a processor, a memory, and a program or an instruction that is stored in the memory and that can be run on the processor, where when the program or the instruction is executed by the processor, the steps of the method in the first aspect are implemented.

According to a sixth aspect, an embodiment of this application provides a terminal. The terminal includes a processor, a memory, and a program or an instruction that is stored in the memory and that can be run on the processor, where when the program or the instruction is executed by the processor, the steps of the method in the second aspect are implemented.

According to a seventh aspect, an embodiment of this application provides a readable storage medium. The readable storage medium stores a program or an instruction, and when the program or the instruction is executed by a processor, the steps of the method in the first aspect are implemented, or when the program or the instruction is executed by a processor, the steps of the method in the second aspect are implemented.

According to an eight aspect, an embodiment of this application provides a chip. The chip includes a processor and a communications interface, the communications interface is coupled to the processor, and the processor is configured to run a program or an instruction of a network side device to implement the method in the first aspect or the method in the second aspect.

In the embodiments of this application, for SL DCI that is used to schedule an SL carrier, an SL cell, an SL resource pool, or an SL BWP, a control resource of the SL DCI is determined by using a target identifier, thereby implementing determining of the control resource of the SL DCI.

### BRIEF DESCRIPTION OF DRAWINGS

FIG. 1 is a block diagram of a wireless communications system to which embodiments of this application can be applied;

FIG. 2 is a first flowchart of a resource determining method according to an embodiment of this application;

FIG. 3 is a second flowchart of a resource determining method according to an embodiment of this application;

FIG. 4 is a first schematic structural diagram of a resource determining apparatus according to an embodiment of this application;

FIG. 5 is a second schematic structural diagram of a resource determining apparatus according to an embodiment of this application;

FIG. 6 is a schematic structural diagram of a communications device according to an embodiment of this application;

FIG. 7 is a schematic structural diagram of a terminal according to an embodiment of this application; and

FIG. 8 is a schematic structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

In the specification and claims of this application, the terms “first”, “second”, and the like are intended to distinguish between similar objects but do not describe a specific order or sequence. It should be understood that, data used in such a way are interchangeable in proper circumstances, so that the embodiments of this application can be implemented in an order other than the order illustrated or described herein. Objects classified by “first”, “second”, and the like are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. The following descriptions describe an NR system for example purposes, and NR terms are used in most of the following descriptions, but these technologies can also be applied to an application other than an NR system application, for example, a 6^{th} generation (6G) communications system.

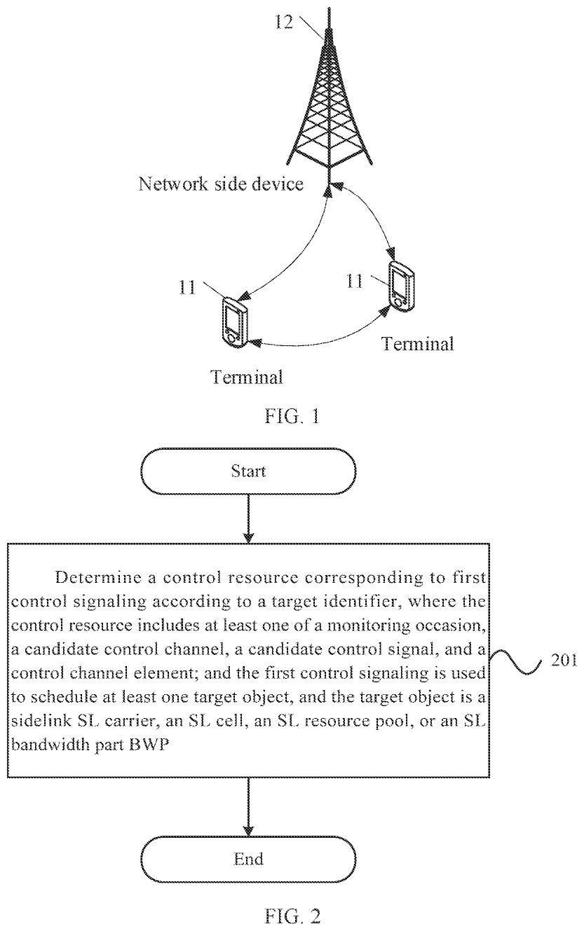

FIG. 1 is a block diagram of a wireless communications system to which embodiments of this application can be applied. The wireless communications system includes a terminal 11 and a network side device 12. The terminal 11 may also be referred to as a terminal device or UE. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), a wearable device, vehicle user equipment (VUE), or pedestrian user equipment (PUE). The wearable device includes a bracelet, a headset, glasses, and the like. It should be noted that a specific type of the terminal 11 is not limited in the embodiments of this application. The network side device 12 may be a base station or a core network. The base station may be referred to as a NodeB, an evolved NodeB, an access point, a base transceiver station (BTS), a radio base station, a radio transceiver, a basic service set (BSS), an extended service set (ESS), a NodeB, an evolved NodeB (eNB), a home NodeB, a home evolved NodeB, a WLAN access point, a Wi-Fi node, a transmitting receiving point (TRP), or another appropriate term in the art. As long as a same technical effect is achieved, the base station is not limited to a specific technical term. It should be noted that, in the embodiments of this application, only a base station in an NR system is used as an example, but a specific type of the base station is not limited.

With reference to the accompanying drawings, the resource determining method and apparatus, the terminal, and the network device provided in the embodiments of this application are described in detail by using specific embodiments and application scenarios.

As shown in FIG. 2, an embodiment of this application provides a resource determining method. The method is performed by a terminal and includes:

Step 201: Determine a control resource corresponding to first control signaling according to a target identifier, where the control resource includes at least one of a monitoring occasion, a candidate control channel, a candidate control signal, or a control channel element.

The first control signaling is used to schedule at least one target object, and the target object is a sidelink SL carrier, an SL cell, an SL resource pool, or an SL bandwidth part BWP.

For example, the first control signaling is DCI used to schedule at least one target object, and may also be referred to as first DCI. In some embodiments, the first control signaling may be at least one of radio resource control RRC, a Media Access Control control element MAC CE, or control signaling SCI on an SL. The control signaling in some embodiments of this application may be at least one of DCI, radio resource control RRC, a Media Access Control control element MAC CE, or control signaling SCI on an SL.

In some embodiments, the first DCI may also be referred to as SL DCI. The terminal may determine, according to configuration information of the first DCI, at least one target object that can be scheduled by using the first DCI.

In some embodiments, the target object may be SL data, an SL signal, an SL channel, or the like. This is not specifically limited herein.

For example, the monitoring occasion may be a search space monitoring occasion, or may be another possible monitoring occasion, for example, a monitoring occasion on a sidelink. The candidate control channel may be a candidate physical downlink control channel PDCCH, or may be another candidate control channel, for example, a candidate physical sidelink control channel PSCCH, such as a candidate physical sidelink control signal SCI. For example, the control channel element may be a CCE (Control Channel Element), or may be another control channel element, for example, a symbol and/or an RB occupied by SCI, or a slot and/or a sub-channel.

In some embodiments, when the first control signaling is used to schedule a plurality of target objects, the plurality of target objects may be interpreted as an SL carrier group, an SL cell group, an SL resource pool group, or an SL BWP group.

The search space monitoring occasion includes at least one of a search space time domain monitoring occasion or a search space frequency domain monitoring occasion.

In some embodiments, step 201 includes:

determining at least one of the following according to the target identifier:

a location of the control resource corresponding to the first control signaling;

a quantity of control resources corresponding to the first control signaling; or

a number of the control resource corresponding to the first control signaling.

The method further includes:

monitoring, receiving, or blindly detecting the first control signaling on the determined control resource. If the first control signaling is obtained, SL receiving and/or SL sending are/is performed according to content of the first control signaling.

In some embodiments, the target identifier includes at least one of the following:

an identifier associated with the first control signaling; or

an identifier associated with the target object.

In some embodiments, the target identifier includes at least one of the following:

an identifier associated with a configuration of a first target object, where for example, the first target object may be one or more specific target objects in the at least one target object;

an identifier associated with a second target object, where for example, the second target object may be one or more specific target objects in the at least one target object; the first target object may be the same or different from the second target object; and for another example, the identifier associated with the second target object may be an SL CIF carried in the first control signaling for the target object;

an identifier associated with a specific cell in a first cell, where the first cell is a cell in which there is at least one of uplink transmission and downlink transmission; for example, the first cell may also be referred to as a Uu cell, and may be understood as a cell that works on a licensed band, a cell that has a Uu interface, or a cell that includes at least one uplink BWP and/or at least one downlink BWP; and it should be noted that a cell may be used only as a Uu cell, or may be used only as an SL cell, or may be used as both a Uu cell and an SL cell, and this is not specifically limited herein;

a specific identifier, for example, 0, 1010, 510, 1100, 501, 1008, a synchronization identifier (for example, an identifier NID jointly carried by an S-SSS and an S-PSS), an identifier corresponding to a sidelink secondary synchronization signal (S-SSS), or an identifier corresponding to a sidelink primary synchronization signal (S-PSS); or

count information associated with the first control signaling.

It should be noted that the foregoing “associating” may be “corresponding”, “relating”, “mapping”, or the like. This is not specifically limited herein.

The count information associated with the first control signaling may be at least one of a number (counter SAI) allocated by the SL and a total quantity (total SAI) allocated by the SL.

In some embodiments, the specific cell in the first cell may be a scheduling cell or a scheduled cell.

In some embodiments, the specific cell in the first cell is any one of the following:

a scheduling cell corresponding to the first control signaling;

a scheduling cell corresponding to the target object;

a scheduled cell corresponding to the first control signaling; or

a scheduled cell corresponding to the target object.

The scheduling cell is a cell in which there is DCI, and the DCI may be used to schedule the cell itself and/or another cell. The scheduled cell is a cell scheduled by using DCI in another cell.

In some embodiments, the specific cell in the first cell includes at least one of the following:

a first cell in which the first control signaling is located, that is, a first cell in which the first control signaling is monitored, received, configured, or blindly detected, which may be interpreted as a scheduling cell corresponding to the first control signaling;

a first cell corresponding to a DCI size budget associated with the first control signaling, where the first cell may be a scheduling cell or a scheduled cell; and in some embodiments, if a size of the first control signaling is not equal to or is not aligned with Uu control signaling, the specific cell in the first cell is the first cell corresponding to the DCI size budget associated with the first control signaling; and in some embodiments, the DCI size budget associated with the first control signaling may be interpreted as a DCI size budget of the first control signaling;

a first cell corresponding to a DCI size budget associated with second control signaling, where the first cell may be a scheduling cell or a scheduled cell; and the second control signaling is Uu control signaling whose size is closest to that of the first control signaling in Uu control signaling that is greater than the first control signaling or Uu control signaling that is considered by the first control signaling for alignment;

a first cell scheduled by using the second control signaling (the first cell may be interpreted as a scheduled cell corresponding to the second DCI);

a first cell in which the second control signaling is located, that is, a first cell in which the second control signaling is monitored, received, configured, or blindly detected, which may be interpreted as a scheduling cell corresponding to the second control signaling;

a first cell corresponding to a DCI size budget associated with third control signaling, where the first cell may be a scheduling cell or a scheduled cell; and a size of the first control signaling is equal to or aligned with a size of the third control signaling;

a first cell scheduled by using the third control signaling, or a scheduled cell corresponding to the third control signaling;

a first cell in which the third control signaling is located, for example, a first cell in which the third control signaling is monitored, received, configured, or blindly detected, or a scheduling cell corresponding to the third control signaling;

a primary cell Pcell;

a primary secondary cell PScell;

a secondary cell Scell;

a first cell that overlaps at least a part of the target object in frequency domain;

a first cell corresponding to a largest identifier in serving cells of the terminal; or

a first cell corresponding to a smallest identifier in the serving cells of the terminal.

The “associating” in “the DCI size budget associated with the first control signaling or the second control signaling or the third control signaling” may also be interpreted as “corresponding”, “belonging”, “considering”, “relating”, or the like. “The DCI size budget associated with the first control signaling or the second control signaling or the third control signaling” may be interpreted as that when the first control signaling or the second control signaling or the third control signaling is the same as or aligned with a DCI size within a budget, the first control signaling or the second control signaling or the third control signaling is associated with the budget, or may be interpreted as that when the first control signaling or the second control signaling or the third control signaling belongs to a budget, it is considered that the signaling is associated with the budget regardless of whether the signaling is aligned with a DCI size within the budget.

In still some embodiments, the identifier corresponding to the second target object includes at least one of the following:

a number corresponding to the second target object, for example, a frequency number;

an SL carrier indicator field CF corresponding to the second target object;

a target parameter n_CI corresponding to the second target object;

an identifier corresponding to an uplink carrier or a downlink carrier associated with the second target object;

an identifier corresponding to an uplink BWP or a downlink BWP associated with the second target object; or

an SL BWP identifier corresponding to the second target object.

In some embodiments, the second target object may be a scheduled target object.

Further, in some embodiments, the identifier corresponding to the specific cell in the first cell in some embodiments of this application includes at least one of the following:

a number corresponding to the specific cell in the first cell, for example, a frequency number or a cell number;

a scheduling cell identifier corresponding to the specific cell in the first cell, where the specific cell in the first cell is a scheduling cell in this case;

a scheduled cell identifier corresponding to the specific cell in the first cell, where the specific cell in the first cell is a scheduled cell in this case;

a carrier indicator field CIF corresponding to the specific cell in the first cell;

a target parameter n_CI corresponding to the specific cell in the first cell, where for example, when the specific cell in the first cell is a scheduling cell, n_CI is 0; or for example, when the specific cell in the first cell is a scheduled cell, n_CI is a corresponding CIF value;

an identifier corresponding to an uplink carrier or a downlink carrier of the specific cell in the first cell, where the uplink or downlink carrier may be an activated uplink or downlink carrier, or may be a preset uplink or downlink carrier; or

an identifier corresponding to an uplink BWP or a downlink BWP of the specific cell in the first cell, where the uplink or downlink BWP may be an activated uplink or downlink BWP, or may be a preset uplink or downlink BWP.

In some embodiments of this application, the method further includes:

in a case that a first condition is met, the target identifier is a specific identifier.

In still some embodiments of this application, the method further includes:

in a case that a first condition is met, the identifier associated with the specific cell in the first cell is a specific identifier.

In some embodiments, the target identifier may be understood as an identifier associated with the first cell. The identifier associated with the specific cell in the first cell is a specific identifier, and therefore the target identifier is a specific identifier.

The first condition includes at least one of the following:

the terminal is configured with N1 first cells, where for example, a cell configuration parameter of the terminal is configured with the N1 first cells, N1 is a natural number, and in some embodiments, N1 is 1, or N1 is a corresponding value not greater than a capability of the terminal; for example, the terminal has only one Uu cell, and in this case, the target identifier is a specific identifier, or the identifier associated with the specific cell in the first cell is a specific identifier; and for example, the cell configuration parameter of the terminal includes only the N1 first cells;

the terminal is configured with N2 first cells in which the first control signaling needs to be monitored, received, or blindly detected, where for example, the cell configuration parameter of the terminal is configured with the N2 first cells in which the first control signaling needs to be monitored, received, or blindly detected, N2 is a natural number, and in some embodiments, N2 is 1, or N2 is a corresponding value not greater than the capability of the terminal; and for example, the cell configuration parameter of the terminal includes only the N2 first cells;

the terminal is configured with N3 target objects, where for example, the cell configuration parameter of the terminal is configured with only the N3 target objects, N3 is a natural number, and in some embodiments, N3 is 1, or N3 is a corresponding value not greater than the capability of the terminal; and for example, the terminal has only one SL carrier, and in this case, the target identifier is a specific identifier, or the identifier associated with the specific cell in the first cell is a specific identifier;

a target object is in a specific frequency domain, where for example, a scheduled SL resource is located in an ITS band or an SL-specific frequency domain, a frequency domain with only an PC5 interface, or a frequency domain that does not coexist with another Uu technology, and in this case, the target identifier is a specific identifier, for example, 0 or 1010;

the specific cell in the first cell has no corresponding identifier, where for example, an identifier corresponding to the first cell is interpreted as a CIF, and if the specific cell in the first cell is not configured with a CIF, it indicates that the specific cell in the first cell has no corresponding identifier, and in this case, the target identifier is a specific identifier, or the identifier associated with the specific cell in the first cell is a specific identifier;

the specific cell in the first cell supports self-scheduling;

the specific cell in the first cell has a control resource;

the specific cell in the first cell has a control resource associated with the first control signaling;

the specific cell in the first cell is a primary cell;

the specific cell in the first cell is a primary secondary cell;

the specific cell in the first cell is a cell in which a feedback resource is located, where for example, the feedback resource is a PUCCH such as a PUCCH primary cell, a PUCCH primary secondary cell, or a PUCCH secondary cell; and in some embodiments, a cell in which the PUCCH is located may be understood as: the specific cell in the first cell and a cell in which the first DCI is located belong to a same PUCCH group, or a hybrid automatic repeat request response HARQ-ACK corresponding to the first DCI is transmitted in the specific cell in the first cell;

the specific cell in the first cell has no downlink resource;

the specific cell in the first cell is not configured with or does not support cross-carrier scheduling; or

the specific cell in the first cell is configured with or supports cross-carrier scheduling and a scheduling cell is the specific cell itself.

In some embodiments of this application, the method further includes:

determining the target identifier according to a network configuration, a preconfiguration, an indication of another terminal, or a protocol agreement, where for example, the target identifier may be configured, preconfigured, reported, or indicated by using radio resource control RRC, a Media Access Control control element MAC CE, DCI, or other signaling;

or

determining, by the terminal, the target identifier, where if the terminal determines the target identifier, the terminal further needs to report the target identifier to the network side device, so that the terminal and the network side device have a consistent understanding of the control resource corresponding to the first control signaling.

It should be noted that the network configuration, the preconfiguration, or the another terminal may directly indicate the target identifier, or a related identifier that can determine the target identifier, for example, the identifier associated with the first control signaling and/or the identifier associated with the target object; or for another example, at least one of the identifier associated with the configuration of the first target object, the identifier associated with the second target object, the identifier associated with the specific cell in the first cell, the specific identifier, and the count information associated with the first control signaling. In other words, the “identifier” in some embodiments of this application may be determined by the network configuration, the preconfiguration, indication of the another terminal, or the terminal itself.

In some embodiments of this application, the first control signaling carries the target identifier. The control resource corresponding to the first control signaling is related to the target identifier carried in the first control signaling.

It should be noted that the first control signaling may directly carry the target identifier, or may carry a related identifier that can determine the target identifier, for example, the identifier associated with the first control signaling and/or the identifier associated with the target object; or for another example, at least one of the identifier associated with the configuration of the first target object, the identifier associated with the second target object, the identifier associated with the specific cell in the first cell, the specific identifier, and the count information associated with the first control signaling. That is, the “identifier” in some embodiments of this application may be carried in the first DCI.

The terminal may obtain the target identifier by decoding the first control signaling. For example, the first control signaling carries an SL CIF, and the CIF may be an ID corresponding to an SL carrier, an SL cell, an SL resource pool, an SL BWP, an SL carrier group, an SL cell group, an SL resource pool group, or an SL BWP group.

For example, the network configures the target identifier by using RRC signaling, and the first control signaling also carries the target identifier. The terminal determines the control resource corresponding to the first control signaling according to the target identifier configured by using the RRC signaling, and blindly detects the first control signaling. Further, in some embodiments, the terminal may determine, according to the target identifier carried in the first control signaling, the target object scheduled by using the first control signaling.

In some embodiments of this application, step 201 includes:

determining the control resource corresponding to the first control signaling according to a correspondence between the target identifier and the control resource.

For example, if the target identifier is 0, calculation of the control resource corresponding to the first control signaling is related to “0”. In some embodiments, the target parameter n_CI may be set to 0, and then is substituted into a preset formula for calculation to obtain the control resource corresponding to the first control signaling.

For another example, the target identifier is n_CI corresponding to a Pcell. Assuming that the Pcell corresponds to n_CI=0, calculation of the control resource corresponding to the first control signaling is related to “0”. In some embodiments, the target parameter n_CI may be set to 0, and then is substituted into a preset formula for calculation to obtain the control resource corresponding to the first control signaling.

For another example, the target identifier is a CIF or n_CI corresponding to a Uu cell. Assuming that the CIF or n_CI=n, calculation of the control resource corresponding to the first control signaling is related to n. In some embodiments, the target parameter n_CI may be set to n, and then is substituted into a preset formula for calculation to obtain the control resource corresponding to the first control signaling.

For another example, the target identifier is an ID corresponding to an SL carrier, an SL cell, an SL resource pool, an SL BWP, an SL carrier group, an SL cell group, an SL resource pool group, or an SL BWP group. Assuming that ID=m, calculation of the control resource corresponding to the first control signaling is related to m. In some embodiments, the target parameter n_CI may be set to m, and then is substituted into a preset formula for calculation to obtain the control resource corresponding to the first control signaling.

In some embodiments, the target identifier is related to a frequency domain location of the target object. When the target object is located on an ITS band (for example, band n47), an SL-specific frequency domain, a frequency domain with only a PC5 interface, or a frequency domain that does not coexist with another Uu technology, the corresponding target identifier is I; when the target object is located in a non-SL-specific frequency domain, a frequency domain with a Uu interface, or a frequency domain that coexists with a Uu technology, or a licensed frequency domain, the corresponding target identifier is J. Further, in some embodiments, I and J are different. For example, J is a specific identifier, such as 0 or 1010. For example, I is n_CI corresponding to a Uu cell in which the first control signaling is located or a Uu cell in which the target object is located.

In some embodiments, the correspondence between the target identifier and the control resource and/or the foregoing formula may be defined as follows:

for a search space s associated with a control resource set p, a CCE index of a candidate PDCCH m_{s,n}_{_{CI}} with an aggregation level L in a slot n_{s,f}^{μ} on a BWP of a cell corresponding to n_{CI} is determined by the following formula:

$$L * \{ ( {Y}_{p , {n}_{s , f}^{μ}} + ⌊ \frac{{m}_{s , {n}_{CI}} * {N}_{CCE , p}}{L * {M}_{s , max}^{( L )}} ⌋ + {n}_{CI} ) mod ⌊ {N}_{CCE , p} / L ⌋ \} + i ,$$

n_{CI} is the target parameter n_CI, or n_{CI} is the target identifier in the present application.

In some embodiments of this application, the control resource corresponding to the first control signaling includes:

a set of control resources corresponding to all target objects.

For example, a set of control resources for scheduling a single carrier, a single cell, a single resource pool or a single BWP for all SL cells, SL carriers, SL resource pools, or SL BWPs in the target object.

In some embodiments of this application, all target objects scheduled by using the first control signaling share a same control resource.

For example, calculation of control resources of A target objects is related to the same target identifier stipulated a protocol or configured or preconfigured, that is, it may be interpreted that the A target objects share a control resource determined according to the same target identifier, where A is an integer greater than or equal to 1. In this case, the determined target identifier is an ID corresponding to an SL carrier, an SL cell, an SL resource pool, an SL BWP, an SL carrier group, an SL cell group, an SL resource pool group, or an SL B WP group, for example, an SL CIF.

In some embodiments of this application, when the first control signaling is monitored, received, or blindly detected on the determined control resource, at least one of the following is met:

a quantity of pieces of first control signaling monitored, received, or blindly detected on the control resource within N4 time units does not exceed M1; or

a quantity of pieces of first control signaling decoded by the terminal on the control resource within N5 time units does not exceed M2, where for example, after decoding M2 pieces of first DCI, a user does not continue to attempt to receive the first DCI; and

N4, N5, M1, and M2 are respectively integers greater than or equal to 1. In some embodiments, N4 is equal to 1, and/or N5 is equal to 1.

The time unit is at least one of a monitoring occasion, a symbol, a span, a slot, a period, a subframe, or a frame.

In some embodiments, the first control signaling meets at least one of the following:

in a case that M1 is greater than 1, M1 pieces of first control signaling have a same size; or

in a case that M2 is greater than 1, M2 pieces of first control signaling have a same size.

It should be noted that for a size of control signaling, or the size of the first control signaling in some embodiments of this application, the size of the control signaling may be understood as a quantity of bits included in the control signaling, and the size of the first control signaling may be understood as a quantity of bits included in the first control signaling.

Further, in some embodiments,

M1 is a sum of a maximum or minimum quantity of pieces of control signaling corresponding to target objects that are of different SL subcarrier spacings and that are scheduled by a same cell; and/or

M2 is a sum of a maximum or minimum quantity of pieces of control signaling of DCI corresponding to target objects that are of different SL subcarrier spacings and that are scheduled by a same cell.

In some embodiments, M1 is a sum of a maximum or minimum quantity of pieces of first control signaling corresponding to target objects that are of different SL subcarrier spacings and that are scheduled by a same cell.

In some embodiments, M2 is a sum of a maximum or minimum quantity of pieces of first control signaling corresponding to target objects that are of different SL subcarrier spacings and that are scheduled by a same cell.

It should be noted that a sum of at least two objects in some embodiments of this application may be interpreted as a direct sum of the at least two objects, or a weighted sum of the at least two objects.

For example, four SL carriers are scheduled, and subcarrier spacings SCSs are respectively 15 kHz, 15 kHz, 30 kHz, and 30 kHz. If there are two different SCSs, 15 kHz may correspond to a quantity of pieces of control signaling, and 30 kHz may correspond to a quantity of pieces of control signaling. Therefore, M1 or M2 is a sum or a weighted sum of the two quantities.

For example, a subcarrier spacing SCS of a Uu cell is 15 kHz, and the cell may schedule four SL component carriers (CC), where an SCS of a part of the SL CC is 15 kHz, and an SCS of a part of the SL CC is 60 kHz. When the first DCI of 15 kHz is used to schedule transmission of 60 kHz, a maximum of two pieces of DCI or two pieces of first DCI are supported in one time unit, and when 15 kHz is used to schedule 15 kHz, a maximum of one piece of DCI or one piece of first DCI is supported in one time unit. Therefore, in this case, M1 or M2=1+2=3.

It should be noted that the first DCI in some embodiments of this application may be SL DCI, that is, DCI used to schedule, activate, or deactivate an SL resource, for example, DCI format 3_x1, where x1 is a natural number; for example, at least one of DCI format 3_0 or DCI format 3_1; or for example, a DCI format scrambled by an SL-RNTI or an SL-CS-RNTI.

Further, it should be noted that the Uu DCI in some embodiments of this application is DCI for scheduling or indicating uplink or downlink signal or channel transmission, or power control, or a slot format, or a quasi-co-location QCL reference or resource allocation, or punching, or power saving control, or a wake-up operation, or a hibernation operation, or sleep. For example, the Uu DCI is DCI format a-b, where a is not 3, and b is greater than or equal to 0. In some embodiments, the Uu DCI may be DCI format 0-x2, DCI format 1-x3, or DCI format 2-x4, where x2, x3, and x4 are all greater than or equal to 0.

In some embodiments of this application, if a first cell in which the first control signaling is monitored, received, or configured can be scheduled by another cell (or the first cell in which the first control signaling is monitored, received, or configured is referred to as a scheduled cell), in a case that the first control signaling is the first DCI, a DCI format supported by the first cell is one of the following:

a first DCI format;

a combination set of a DCI format of a cell scheduling the first cell and the first DCI format; or

an intersection set of the DCI format of the cell scheduling the first cell and the first DCI format.

The DCI format of the cell scheduling the first cell is a DCI format included in a search space configuration of the cell scheduling the first cell.

For example, if the first cell is a Uu cell, a DCI format supported by the Uu cell is a combination set or an intersection of the first DCI format and a DCI format included in a search space configuration of the Uu cell scheduling the first cell, or a DCI format supported by the Uu cell is a combination set or an intersection of a DCI format included in a search space configuration of the Uu cell scheduling the first cell and a DCI format in a cell configuration of the first cell.

For another example, if the first cell is a Uu cell, a DCI format supported by the Uu cell is the first DCI format. In some embodiments, a configuration of the first DCI format covers a configuration of a DCI format included in a search space configuration of the Uu cell scheduling the first cell, or the terminal ignores a configuration of a DCI format included in a search space configuration of the Uu cell scheduling the first cell.

In still some embodiments of this application, if a first cell in which the first control signaling is monitored, received, or configured can be scheduled by another cell (or the first cell in which the first control signaling is monitored, received, or configured is referred to as a scheduled cell), in a case that the first control signaling is the first DCI, a configuration of the first cell includes a control resource configuration, and the control resource configuration includes at least one of the following:

a DCI format configuration, for example, dci-FormatsSL-r16, where in some embodiments, the DCI format configuration may be set to the first DCI;

a control resource set configuration, for example, a control resource set CORESET resource configuration; and

a search space configuration, for example, a search space time domain location configuration, or a search space frequency domain location configuration.

It should be noted that, the first cell is a cell in which there is at least one of uplink transmission and downlink transmission. The first cell may also be referred to as a Uu cell.

In some embodiments, in a case that the first control signaling is the first DCI, the configuration of the at least one target object scheduled by using the first control signaling includes a DCI format configuration, for example, dci-FormatsSL-r16. In some embodiments, the DCI format configuration may be set to the first DCI.

In some embodiments, in a case that the first control signaling is the first DCI, a DCI format supported by the at least one target object scheduled by using the first control signaling is any one of the following:

a first DCI format;

a combination set of a DCI format supported by a cell scheduling the target object and the first DCI format; and

an intersection set of the DCI format supported by the cell scheduling the target object and the first DCI format.

For example, the DCI format supported by the target object is a combination set or an intersection set of the first DCI and a DCI format configuration included in a search space configuration of a Uu cell scheduling the target object, or the DCI format supported by the target object is a combination set or an intersection set of a DCI format in the DCI format configuration and a DCI format configuration included in a search space configuration of a Uu cell scheduling the target object. For example, when the target object is located on a non-ITS bandwidth or is a shared carrier or a licensed band, or the target object is also a Uu cell or a carrier, or Uu transmission exists in the target object, the DCI format supported by the target object is the first DCI and the DCI format configuration included in the search space configuration of the Uu cell scheduling the target object.

For another example, the DCI format supported by the target object is the first DCI or the format in the DCI format configuration, and the first DCI or the DCI format configuration covers the DCI format configuration included in the search space configuration of the Uu cell scheduling the target object. In some embodiments, the terminal ignores the DCI format configuration included in the search space configuration of the Uu cell scheduling the target object. For example, when the target object is located on an ITS bandwidth or is an SL dedicated carrier or an SL dedicated band, the DCI format supported by the target object is the first DCI, or it may be understood that the first DCI covers a DCI format configuration included in a search space configuration of a cell in which the SL DCI is located.

In some embodiments of this application, a time unit corresponding to the first control signaling is different from a time unit corresponding to fourth control signaling; or a time interval between the first control signaling and fourth control signaling is greater than or equal to L time units, where L is an integer greater than or equal to 1.

For example, the terminal does not expect that the first control signaling and the fourth control signaling appear in a same time unit or the user does not expect that the time interval between the first control signaling and the fourth control signaling is not greater than L. In some embodiments, the terminal expects that the first control signaling and the fourth control signaling appear in different time units or the terminal expects that the time interval between the first control signaling and the fourth control signaling is not greater than L.

The fourth control signaling includes at least one of the following:

Uu control signaling, that is, Uu control signaling for scheduling any cell, where for example, the SL DCI is sent on a component carrier (CC) 1, and the CC 1 may schedule the CC 1 and a CC 2, and therefore at least one of Uu DCI for scheduling the CC 1 and Uu DCI for scheduling the CC 2 and the SL DCI do not appear in a same time unit or a time interval is greater than L; and

SL control signaling for scheduling a target object different from the target object scheduled by using the first control signaling, where for example, SL DCI for scheduling an SL cell 1 or a carrier 1 and SL DCI for scheduling an SL cell 2 or a carrier 2 do not appear in a same time unit or a time interval is greater than L.

In some embodiments, the Uu control signaling includes at least one of the following:

Uu control signaling for scheduling a first target cell, where the first target cell is a cell in which the first control signaling is located; and

Uu control signaling for scheduling a second target cell, where the second target cell is a cell other than the first target cell. Further, in some embodiments, the second target cell is a cell other than the first target cell in cells scheduled by the first target cell.

Further, in some embodiments, the second target cell is a Uu cell or a non-SL cell. For example, the SL DCI is sent on the CC 1, and the Uu DCI on the CC 1 may be used to schedule the CC 2. Therefore, the Uu DCI for scheduling the CC 2 and the SL DCI do not appear in a same time unit or a time interval is greater than L.

It should be noted that when the fourth DCI is Uu DCI, the fourth DCI may be at least one of DCI for uplink scheduling and Uu DCI for downlink scheduling.

In some embodiments, the fourth control signaling is sent in the first target cell. The first target cell is a cell in which the first control signaling is located.

Further, it should be noted that “corresponding” and “associating” in some embodiments of this application may also be understood as “relating”, “mapping”, “belonging”, “considering”, or the like. This is not specifically limited herein.

In conclusion, in some embodiments of this application, for SL DCI that is used to schedule an SL carrier, an SL cell, an SL resource pool, or an SL BWP, a control resource of the SL DCI is determined by using a target identifier, thereby implementing determining of the control resource of the SL DCI.

As shown in FIG. 3, an embodiment of this application further provides a resource determining method. The method is performed by a network side device and includes:

Step 301: Determine a control resource corresponding to first control signaling according to a target identifier, where the control resource includes at least one of a monitoring occasion, a candidate control channel, a candidate control signal, and a control channel element.

The first control signaling is used to schedule at least one target object, and the target object is a sidelink SL carrier, an SL cell, an SL resource pool, or an SL bandwidth part BWP.

For example, the first control signaling is DCI used to schedule at least one target object, and may also be referred to as first DCI. In some embodiments, the first control signaling may be at least one of radio resource control RRC, a Media Access Control control element MAC CE, and control signaling SCI on an SL. The control signaling in some embodiments of this application may be at least one of DCI, radio resource control RRC, a Media Access Control control element MAC CE, and control signaling SCI on an SL.

In some embodiments, the first DCI may also be referred to as SL DCI. The terminal may determine, according to configuration information of the first DCI, at least one target object that can be scheduled by using the first DCI.

In some embodiments, the target object may be SL data, an SL signal, an SL channel, or the like. This is not specifically limited herein.

For example, the monitoring occasion may be a search space monitoring occasion, or may be another possible monitoring occasion, for example, a monitoring occasion on a sidelink. The candidate control channel may be a candidate physical downlink control channel PDCCH, or may be another candidate control channel, for example, a candidate physical sidelink control channel PSCCH, such as a candidate physical sidelink control signal SCI. For example, the control channel element may be a CCE (Control Channel Element), or may be another control channel element, for example, a symbol and/or an RB occupied by SCI, or a slot and/or a sub-channel.

In some embodiments, when the first control signaling is used to schedule a plurality of target objects, the plurality of target objects may be interpreted as an SL carrier group, an SL cell group, an SL resource pool group, or an SL BWP group.

The search space monitoring occasion includes at least one of a search space time domain monitoring occasion and a search space frequency domain monitoring occasion.

In some embodiments, step 301 includes:

determining at least one of the following according to the target identifier:

a location of the control resource corresponding to the first control signaling;

a quantity of control resources corresponding to the first control signaling; and

a number of the control resource corresponding to the first control signaling.

The method further includes:

sending the first control signaling on the determined control resource.

In some embodiments, the target identifier includes at least one of the following:

an identifier associated with the first control signaling; and

an identifier associated with the target object.

In some embodiments, the target identifier includes at least one of the following:

an identifier associated with a configuration of a first target object, where for example, the first target object may be one or more specific target objects in the at least one target object;

an identifier associated with a second target object, where for example, the second target object may be one or more specific target objects in the at least one target object; the first target object may be the same or different from the second target object; for another example, the identifier associated with the second target object may be an SL CIF carried in the first control signaling for the target object; and the second target object is one of the at least one target object;

an identifier associated with a specific cell in a first cell, where the first cell is a cell in which there is at least one of uplink transmission and downlink transmission; for example, the first cell may also be referred to as a Uu cell, and may be understood as a cell that works on a licensed band, a cell that has a Uu interface, or a cell that includes at least one uplink BWP and/or at least one downlink BWP; and it should be noted that a cell may be used only as a Uu cell, or may be used only as an SL cell, or may be used as both a Uu cell and an SL cell, and this is not specifically limited herein;

a specific identifier, for example, 0, 1010, 510, 1100, 501, 1008, a synchronization identifier (for example, an identifier NID jointly carried by an S-SSS and an S-PSS), an identifier corresponding to a sidelink secondary synchronization signal (S-SSS), or an identifier corresponding to a sidelink primary synchronization signal (S-PSS); and

count information associated with the first control signaling.

It should be noted that the foregoing “associating” may be “corresponding”, “relating”, “mapping”, or the like. This is not specifically limited herein.

The count information associated with the first control signaling may be at least one of a number (counter SAI) allocated by the SL and a total quantity (total SAI) allocated by the SL.

In some embodiments, the specific cell in the first cell may be a scheduling cell or a scheduled cell.

In some embodiments, the specific cell in the first cell is any one of the following:

a scheduling cell corresponding to the first control signaling;

a scheduling cell corresponding to the target object;

a scheduled cell corresponding to the first control signaling; and

a scheduled cell corresponding to the target object.

The scheduling cell is a cell in which there is DCI, and the DCI may be used to schedule the cell itself and/or another cell. The scheduled cell is a cell scheduled by using DCI in another cell.

In some embodiments, the specific cell in the first cell includes at least one of the following:

a first cell in which the first control signaling is sent, which may be interpreted as a scheduling cell corresponding to the first control signaling;

a first cell corresponding to a DCI size budget associated with the first control signaling, where the first cell may be a scheduling cell or a scheduled cell; and in some embodiments, if a size of the first control signaling is not equal to or is not aligned with Uu control signaling, the specific cell in the first cell is the first cell corresponding to the DCI size budget associated with the first control signaling; and in some embodiments, the DC size budget associated with the first control signaling may be interpreted as a DCI size budget of the first control signaling;

a first cell corresponding to a DCI size budget associated with second control signaling, where the first cell may be a scheduling cell or a scheduled cell; and the second control signaling is Uu control signaling whose size is closest to that of the first control signaling in Uu control signaling that is greater than the first control signaling or Uu control signaling that is considered by the first control signaling for alignment;

a first cell scheduled by using the second control signaling (the first cell may be interpreted as a scheduled cell corresponding to the second DCI);

a first cell in which the second control signaling is sent, which may be interpreted as a scheduling cell corresponding to the second control signaling;

a first cell corresponding to a DCI size budget associated with third control signaling, where the first cell may be a scheduling cell or a scheduled cell; and a size of the first control signaling is equal to or aligned with a size of the third control signaling;

a first cell scheduled by using the third control signaling, or a scheduled cell corresponding to the third control signaling;

a first cell in which the third control signaling is sent, that is, a first cell in which the third control signaling is monitored, received, configured, or blindly detected, which may be interpreted as a scheduling cell corresponding to the third control signaling;

a primary cell Pcell;

a primary secondary cell PScell;

a secondary cell Scell;

a first cell that overlaps at least a part of the target object in frequency domain;

a first cell corresponding to a largest identifier in serving cells of the terminal; and

a first cell corresponding to a smallest identifier in the serving cells of the terminal.

The “associating” in “the DCI size budget associated with the first control signaling or the second control signaling or the third control signaling” may also be interpreted as “corresponding”, “belonging”, “considering”, “relating”, or the like. “The DCI size budget associated with the first control signaling or the second control signaling or the third control signaling” may be interpreted as that when the first control signaling or the second control signaling or the third control signaling is the same as or aligned with a DCI size within a budget, the first control signaling or the second control signaling or the third control signaling is associated with the budget, or may be interpreted as that when the first control signaling or the second control signaling or the third control signaling belongs to a budget, it is considered that the signaling is associated with the budget regardless of whether the signaling is aligned with a DCI size within the budget.

In still some embodiments, the identifier corresponding to the second target object includes at least one of the following:

a number corresponding to the second target object, for example, a frequency number;

an SL carrier indicator field CIF corresponding to the second target object;

a target parameter n_CI corresponding to the second target object;

an identifier corresponding to an uplink carrier or a downlink carrier associated with the second target object;

an identifier corresponding to an uplink BWP or a downlink BWP associated with the second target object; and

an SL BWP identifier corresponding to the second target object.

In some embodiments, the second target object may be a scheduled target object.

Further, in some embodiments, the identifier corresponding to the specific cell in the first cell in some embodiments of this application includes at least one of the following:

a number corresponding to the specific cell in the first cell, for example, a frequency number or a cell number;

a scheduling cell identifier corresponding to the specific cell in the first cell, where the specific cell in the first cell is a scheduling cell in this case;

a scheduled cell identifier corresponding to the specific cell in the first cell, where the specific cell in the first cell is a scheduled cell in this case;

a carrier indicator field CIF corresponding to the specific cell in the first cell;

a target parameter n_CI corresponding to the specific cell in the first cell, where for example, when the specific cell in the first cell is a scheduling cell, n_CI is 0; or for example, when the specific cell in the first cell is a scheduled cell, n_CI is a corresponding CIF value;

an identifier corresponding to an uplink carrier or a downlink carrier of the specific cell in the first cell, where the uplink or downlink carrier may be an activated uplink or downlink carrier, or may be a preset uplink or downlink carrier; and

an identifier corresponding to an uplink BWP or a downlink BWP of the specific cell in the first cell, where the uplink or downlink BWP may be an activated uplink or downlink BWP, or may be a preset uplink or downlink BWP.

In some embodiments of this application, the method further includes:

in a case that a first condition is met, the target identifier is a specific identifier.

In still some embodiments of this application, the method further includes:

in a case that a first condition is met, the identifier associated with the specific cell in the first cell is a specific identifier. In some embodiments, the target identifier may be understood as an identifier associated with the first cell. The identifier associated with the specific cell in the first cell is a specific identifier, and therefore the target identifier is a specific identifier.

The first condition includes at least one of the following:

the terminal is configured with N1 first cells, where N1 is a natural number, and in some embodiments, N1 is 1, or N1 is a corresponding value not greater than a capability of the terminal; and for example, the terminal has only one Uu cell, and in this case, the target identifier is a specific identifier, or the identifier associated with the specific cell in the first cell is a specific identifier;

the terminal is configured with N2 first cells in which the first control signaling needs to be monitored, received, or blindly detected, where N2 is a natural number, and in some embodiments, N2 is 1, or N2 is a corresponding value not greater than the capability of the terminal;

the terminal is configured with N3 target objects, where N3 is a natural number, and in some embodiments, N3 is 1, or N3 is a corresponding value not greater than the capability of the terminal; and for example, the terminal has only one SL carrier, and in this case, the target identifier is a specific identifier, or the identifier associated with the specific cell in the first cell is a specific identifier;

a target object is in a specific frequency domain, where for example, a scheduled SL resource is located in an ITS band or an SL-specific frequency domain, a frequency domain with only an PC5 interface, or a frequency domain that does not coexist with another Uu technology, and in this case, the target identifier is a specific identifier, for example, 0 or 1010;

the specific cell in the first cell has no corresponding identifier, where for example, an identifier corresponding to the first cell is interpreted as a CIF, and if the specific cell in the first cell is not configured with a CIF, it indicates that the specific cell in the first cell has no corresponding identifier, and in this case, the target identifier is a specific identifier, or the identifier associated with the specific cell in the first cell is a specific identifier;

the specific cell in the first cell supports self-scheduling;

the specific cell in the first cell has a control resource;

the specific cell in the first cell has a control resource associated with the first control signaling;

the specific cell in the first cell is a primary cell;

the specific cell in the first cell is a primary secondary cell;

the specific cell in the first cell is a cell in which a feedback resource is located, where for example, the feedback resource is a PUCCH such as a PUCCH primary cell, a PUCCH primary secondary cell, or a PUCCH secondary cell; and in some embodiments, a cell in which the PUCCH is located may be understood as: the specific cell in the first cell and a cell in which the first DCI is located belong to a same PUCCH group, or a hybrid automatic repeat request response HARQ-ACK corresponding to the first DCI is transmitted in the specific cell in the first cell;

the specific cell in the first cell has no downlink resource;

the specific cell in the first cell is not configured with or does not support cross-carrier scheduling; and

the specific cell in the first cell is configured with or supports cross-carrier scheduling and a scheduling cell is the specific cell itself.

In some embodiments of this application, the method further includes:

determining the target identifier according to a configuration, a preconfiguration, or a protocol agreement, or by the network side device.

The network side device may further configure, preconfigure, report, or indicate the target identifier by using radio resource control RRC or a Media Access Control control element MAC CE, DCI, or other signaling.

It should be noted that the target identifier, or a related identifier that can determine the target identifier may be configured, preconfigured, or determined by the network side device, for example, the identifier associated with the first control signaling and/or the identifier associated with the target object; or for another example, at least one of the identifier associated with the configuration of the first target object, the identifier associated with the second target object, the identifier associated with the specific cell in the first cell, the specific identifier, and the count information associated with the first control signaling. In other words, the “identifier” in some embodiments of this application may be configured, preconfigured, or determined by the network side device.

In some embodiments of this application, the first control signaling carries the target identifier. The control resource corresponding to the first control signaling is related to the target identifier carried in the first control signaling.

It should be noted that the first control signaling may directly carry the target identifier, or may carry a related identifier that can determine the target identifier, for example, the identifier associated with the first control signaling and/or the identifier associated with the target object; or for another example, at least one of the identifier associated with the configuration of the first target object, the identifier associated with the second target object, the identifier associated with the specific cell in the first cell, the specific identifier, and the count information corresponding to the first control signaling. That is, the “identifier” in some embodiments of this application may be carried in the first control signaling.

The terminal may obtain the target identifier by decoding the first control signaling. For example, the first control signaling carries an SL CIF, and the CIF may be an ID corresponding to an SL carrier, an SL cell, an SL resource pool, an SL BWP, an SL carrier group, an SL cell group, an SL resource pool group, or an SL BWP group.

For example, the network configures the target identifier by using RRC signaling, and the first control signaling also carries the target identifier. The terminal determines the control resource corresponding to the first control signaling according to the target identifier configured by using the RRC signaling, and blindly detects the first control signaling. Further, in some embodiments, the terminal may determine, according to the target identifier carried in the first control signaling, the target object scheduled by using the first control signaling.

In some embodiments of this application, step 301 includes:

For example, if the target identifier is 0, calculation of the control resource corresponding to the first control signaling is related to “0”. In some embodiments, the target parameter n_CI may be set to 0, and then is substituted into a preset formula for calculation to obtain the control resource corresponding to the first control signaling.

For another example, the target identifier is n_CI corresponding to a Pcell. Assuming that the Pcell corresponds to n_CI=, calculation of the control resource corresponding to the first control signaling is related to “0”. In some embodiments, the target parameter n_CI may be set to 0, and then is substituted into a preset formula for calculation to obtain the control resource corresponding to the first control signaling.

For another example, the target identifier is a CIF or n_CI corresponding to a Uu cell. Assuming that the CIF or n_CI=n, calculation of the control resource corresponding to the first control signaling is related to n. In some embodiments, the target parameter n_CI may be set to n, and then is substituted into a preset formula for calculation to obtain the control resource corresponding to the first control signaling.

For another example, the target identifier is an ID corresponding to an SL carrier, an SL cell, an SL resource pool, an SL BWP, an SL carrier group, an SL cell group, an SL resource pool group, or an SL BWP group. Assuming that ID=m, calculation of the control resource corresponding to the first control signaling is related to m. In some embodiments, the target parameter n_CI may be set to m, and then is substituted into a preset formula for calculation to obtain the control resource corresponding to the first control signaling.

In some embodiments, the target identifier is related to a frequency domain location of the target object. When the target object is located on an ITS band (for example, band n47), an SL-specific frequency domain, a frequency domain with only a PC5 interface, or a frequency domain that does not coexist with another Uu technology, the corresponding target identifier is I; when the target object is located in a non-SL-specific frequency domain, a frequency domain with a Uu interface, or a frequency domain that coexists with a Uu technology, or a licensed frequency domain, the corresponding target identifier is J. Further, in some embodiments, I and J are different. For example, J is a specific identifier, such as 0 or 1010. For example, I is n_CI corresponding to a Uu cell in which the first control signaling is located or a Uu cell in which the target object is located.

In some embodiments, the correspondence between the target identifier and the control resource and/or the foregoing formula may be defined as follows:

for a search space s associated with a control resource set p, a CCE index of a candidate PDCCH m_{s,n}_{_{CI}} with an aggregation level L in a slot n_{s,f}^{μ} on a BWP of a cell corresponding to n_{CI} is determined by the following formula:

$$L * \{ ( {Y}_{p , {n}_{s , f}^{μ}} + ⌊ \frac{{m}_{s , {n}_{CI}} * {N}_{CCE , p}}{L * {M}_{s , max}^{( L )}} ⌋ + {n}_{CI} ) mod ⌊ {N}_{CCE , p} / L ⌋ \} + i ,$$

n_{CI} is the target parameter n_CI, or n_{CI} is the target identifier in the present application.

In some embodiments of this application, the control resource corresponding to the first control signaling includes:

a set of control resources corresponding to all target objects.

For example, a set of control resources for scheduling a single carrier, a single cell, a single resource pool or a single BWP for all SL cells, SL carriers, SL resource pools, or SL BWPs in the target object.

In some embodiments of this application, all target objects scheduled by using the first control signaling share a same control resource.

For example, calculation of control resources of A target objects is related to the same target identifier stipulated a protocol or configured or preconfigured, that is, it may be interpreted that the A target objects share a control resource determined according to the same target identifier, where A is an integer greater than or equal to 1. In this case, the determined target identifier is an ID corresponding to an SL carrier, an SL cell, an SL resource pool, an SL BWP, an SL carrier group, an SL cell group, an SL resource pool group, or an SL B WP group, for example, an SL CIF.

In some embodiments of this application, when the first control signaling is sent on the determined control resource,

a quantity of pieces of first control signaling sent on the control resource within N6 time units does not exceed M3, where

N6 and M3 are respectively integers greater than or equal to 1. In some embodiments, N6 is equal to 1.

The time unit is at least one of a monitoring occasion, a symbol, a span, a slot, a period, a subframe, or a frame.

In some embodiments, the method meets at least one of the following:

in a case that M3 is greater than 1, M3 pieces of first control signaling have a same size.

It should be noted that for a size of control signaling, or the size of the first control signaling in some embodiments of this application, the size of the control signaling may be understood as a quantity of bits included in the control signaling, and the size of the first control signaling may be understood as a quantity of bits included in the first control signaling.

Further, in some embodiments, the method further meets at least one of the following:

M3 is a sum of a maximum or minimum quantity of pieces of control signaling corresponding to target objects that are of different SL subcarrier spacings and that are scheduled by a same cell (the sum herein may be interpreted as a direct sum or a weighted sum).

In some embodiments, M3 is a sum of a maximum or minimum quantity of pieces of first control signaling corresponding to target objects that are of different SL subcarrier spacings and that are scheduled by a same cell (the sum herein may be interpreted as a direct sum or a weighted sum).

For example, a subcarrier spacing SCS of a Uu cell is 15 kHz, and the cell may schedule four SL component carriers (CC), where an SCS of a part of the SL CC is 15 kHz, and an SCS of a part of the SL CC is 60 kHz. When the first DCI of 15 kHz is used to schedule transmission of 60 kHz, a maximum of two pieces of DCI or two pieces of first DCI are supported in one time unit, and when 15 kHz is used to schedule 15 kHz, a maximum of one piece of DCI or one piece of first DCI is supported in one time unit. Therefore, in this case, M3=1+2=3.

It should be noted that the first DCI in some embodiments of this application may be SL DCI, that is, DCI used to schedule, activate, or deactivate an SL resource, for example, DCI format 3_x1 where x1 is a natural number; for example, at least one of DCI format 3_0 and DCI format 3_1; or for example, a DCI format scrambled by an SL-RNTI or an SL-CS-RNTI.

Further, it should be noted that the Uu DCI in some embodiments of this application is DCI for scheduling or indicating uplink or downlink signal or channel transmission, or power control, or a slot format, or a quasi-co-location QCL reference or resource allocation, or punching, or power saving control, or a wake-up operation, or a hibernation operation, or sleep. For example, the Uu DCI is DCI format a-b, where a is not 3, and b is greater than or equal to 0. In some embodiments, the Uu DCI may be DCI format 0-x2, DCI format 1-x3, or DCI format 2-x4, where x2, x3, and x4 are all greater than or equal to 0.

In some embodiments of this application, if a first cell in which the first control signaling is monitored, received, or configured can be scheduled by another cell (or the first cell in which the first DCI is monitored, received, or configured is referred to as a scheduled cell), in a case that the first control signaling is the first DCI, a DCI format supported by the first cell is one of the following:

a first DCI format;

a combination set of a DCI format of a cell scheduling the first cell and the first DCI format; and

an intersection set of the DCI format of the cell scheduling the first cell and the first DCI format.

The DCI format of the cell scheduling the first cell is a DCI format included in a search space configuration of the cell scheduling the first cell.

For example, if the first cell is a Uu cell, a DCI format supported by the Uu cell is a combination set or an intersection of the first DCI format and a DCI format included in a search space configuration of the Uu cell scheduling the first cell, or a DCI format supported by the Uu cell is a combination set or an intersection of a DCI format included in a search space configuration of the Uu cell scheduling the first cell and a DCI format in a cell configuration of the first cell.

For another example, if the first cell is a Uu cell, a DCI format supported by the Uu cell is the first DCI format. In some embodiments, a configuration of the first DCI format covers a configuration of a DCI format included in a search space configuration of the Uu cell scheduling the first cell, or the terminal ignores a configuration of a DCI format included in a search space configuration of the Uu cell scheduling the first cell.

In still some embodiments of this application, if a first cell in which the first control signaling is monitored, received, or configured can be scheduled by another cell (or the first cell in which the first DCI is monitored, received, or configured is referred to as a scheduled cell), in a case that the first control signaling is the first DCI, a configuration of the first cell includes a control resource configuration, and the control resource configuration includes at least one of the following:

a DCI format configuration, for example, dci-FormatsSL-r16, where in some embodiments, the DCI format configuration may be set to the first DCI;

a control resource set configuration, for example, a control resource set CORESET resource configuration; and

a search space configuration, for example, a search space time domain location configuration, or a search space frequency domain location configuration.

It should be noted that, the first cell is a cell in which there is at least one of uplink transmission and downlink transmission. The first cell may also be referred to as a Uu cell.

In some embodiments, in a case that the first control signaling is the first DCI, the configuration of the at least one target object scheduled by using the first control signaling includes a DCI format configuration, for example, dci-FormatsSL-r16. In some embodiments, the DCI format configuration may be set to the first DCI.

In some embodiments, in a case that the first control signaling is the first DCI, a DCI format supported by the at least one target object scheduled by using the first control signaling is any one of the following:

For example, the DCI format supported by the target object is a combination set or an intersection set of the first DCI and a DCI format configuration included in a search space configuration of a Uu cell scheduling the target object, or the DCI format supported by the target object is a combination set or an intersection set of a DCI format in the DCI format configuration and a DCI format configuration included in a search space configuration of a Uu cell scheduling the target object. For example, when the target object is located on a non-ITS bandwidth or is a shared carrier or a licensed band, or the target object is also a Uu cell or a carrier, or Uu transmission exists in the target object, the DCI format supported by the target object is the first DCI and the DCI format configuration included in the search space configuration of the Uu cell scheduling the target object.

For another example, the DCI format supported by the target object is the first DCI or the format in the DCI format configuration, and the first DCI or the DCI format configuration covers the DCI format configuration included in the search space configuration of the Uu cell scheduling the target object. In some embodiments, the terminal ignores the DCI format configuration included in the search space configuration of the Uu cell scheduling the target object. For example, when the target object is located on an ITS bandwidth or is an SL dedicated carrier or an SL dedicated band, the DCI format supported by the target object is the first DCI, or it may be understood that the first DCI covers a DCI format configuration included in a search space configuration of a cell in which the SL DCI is located.

In some embodiments of this application, a time unit corresponding to the first control signaling is different from a time unit corresponding to fourth control signaling; or a time interval between the first control signaling and fourth control signaling is greater than or equal to L time units, where L is an integer greater than or equal to 1.

For example, the terminal does not expect that the first control signaling and the fourth control signaling appear in a same time unit or the user does not expect that the time interval between the first control signaling and the fourth control signaling is not greater than L. In some embodiments, the terminal expects that the first control signaling and the fourth control signaling appear in different time units or the terminal expects that the time interval between the first control signaling and the fourth control signaling is not greater than L.

The fourth control signaling includes at least one of the following:

Uu control signaling, that is, Uu control signaling for scheduling any cell, where for example, the SL DCI is sent on a component carrier (CC) 1, and the CC 1 may schedule the CC 1 and a CC 2, and therefore at least one of Uu DCI for scheduling the CC 1 and Uu DCI for scheduling the CC 2 and the SL DC do not appear in a same time unit or a time interval is greater than L; and

SL control signaling for scheduling a target object different from the target object scheduled by using the first control signaling, where for example, SL DCI for scheduling an SL cell 1 or a carrier 1 and SL DCI for scheduling an SL cell 2 or a carrier 2 do not appear in a same time unit or a time interval is greater than L.

In some embodiments, the Uu control signaling includes at least one of the following:

Uu control signaling for scheduling a first target cell, where the first target cell is a cell in which the first control signaling is located; and

Uu control signaling for scheduling a second target cell, where the second target cell is a cell other than the first target cell. Further, in some embodiments, the second target cell is a cell other than the first target cell in cells scheduled by the first target cell.

Further, in some embodiments, the second target cell is a Uu cell or a non-SL cell. For example, the SL DCI is sent on the CC 1, and the Uu DCI on the CC 1 may be used to schedule the CC 2. Therefore, the Uu DCI for scheduling the CC 2 and the SL DC do not appear in a same time unit or a time interval is greater than L.

It should be noted that when the fourth DCI is Uu DCI, the fourth DCI may be at least one of DCI for uplink scheduling and Uu DCI for downlink scheduling.

In some embodiments, the fourth control signaling is sent in the first target cell. The first target cell is a cell in which the first control signaling is located.

Further, it should be noted that “corresponding” and “associating” in some embodiments of this application may also be understood as “relating”, “mapping”, “belonging”, “considering”, or the like. This is not specifically limited herein.

In conclusion, in some embodiments of this application, for SL DCI that is used to schedule an SL carrier, an SL cell, an SL resource pool, an SL BWP, an SL carrier group, an SL cell group, an SL resource pool group, or an SL BWP group, a control resource of the SL DCI is determined by using a target identifier, thereby implementing determining of the control resource of the SL DCI.

It should be noted that the resource determining method provided in the embodiments of this application may be performed by a resource determining apparatus, or a control module that is in the resource determining apparatus and that is configured to perform the resource determining method. In the embodiments of this application, that the resource determining apparatus performs the resource determining method is used as an example to describe the resource determining apparatus provided in the embodiments of this application.

### Example 1: Determine the Control Resource Based on an SL Carrier Number

The terminal is configured with an SL carrier. In this case, the target identifier is a specific identifier, for example, 0. The user calculates a search space monitoring occasion and/or a candidate PDCCH and/or CCE based on 0.

In some embodiments, if the terminal is configured with a plurality of SL carriers or the user chooses to perform transmissions on a plurality of SL carriers, the identifier is an identifier corresponding to the SL carrier, and a search space monitoring occasion and/or a candidate PDCCH and/or CCE are/is separately calculated based on the identifier. For example, an occasion corresponding to each SL carrier is an SL CIF or an SL carrier number, and the search space monitoring occasion and/or the candidate PDCCH and/or CCE are/is separately calculated and determined based on the CIF or the number of each SL carrier.

### Example 2

Case 1: The terminal is configured with one Uu cell (cell #1) and one SL carrier, cell, carrier group, or cell group.

The first DCI is transmitted on the cell #1. In this case, the target identifier is an ID corresponding to the cell #1 or a specific ID, or n_CI is an ID corresponding to the cell #1 or a specific ID. Therefore, the terminal determines the control resource based on the ID corresponding to the cell #1 or the specific ID. In some embodiments, the ID corresponding to the cell #1 or the specific ID is 0.

Case 2: The terminal is configured with P Uu cells (for example, P=2, cell #1 and cell #2) and one SL carrier, cell, carrier group, or cell group, and at least one of the following cases is included:

Case 2-1: The first DCI is transmitted on the cell #1, and the cell #2 is scheduled by the cell #1.

In this case, the identifier is an ID corresponding to the cell #1 or a specific ID, or n_CI is an ID corresponding to the cell #1 or a specific ID. Therefore, the user determines the control resource based on the ID corresponding to the cell #1 or the specific ID. In some embodiments, the ID corresponding to the cell #1 or the specific ID is 0. In some embodiments, in this case, the identifier is an ID corresponding to the cell #2, or n_CI is an ID corresponding to the cell #2. Therefore, the user determines the control resource based on the ID corresponding to the cell #2. In some embodiments, the ID corresponding to the cell #2 is a CIF corresponding to the cell #2.

Case 2-2: The first DCI is transmitted on the cell #1, and the cell #2 is self-scheduled. In this case, the identifier is an ID corresponding to the cell #1 or a specific ID, or n_CI is an ID corresponding to the cell #1 or a specific ID. Therefore, the user determines the control resource based on the ID corresponding to the cell #1 or the specific ID. In some embodiments, the ID corresponding to the cell #1 or the specific ID is 0.

Case 2-3: The first DCI is transmitted on the cell #2, and the cell #2 schedules the cell #1.

In this case, the identifier is an ID corresponding to the cell #2 or a specific ID, or n_CI is an ID corresponding to the cell #2 or a specific ID. Therefore, the user determines the control resource based on the ID corresponding to the cell #2 or the specific ID. In some embodiments, the ID corresponding to the cell #2 or the specific ID is 0.

In some embodiments, in this case, the identifier is an ID corresponding to the cell #1, or n_CI is an ID corresponding to the cell #1. Therefore, the user determines the control resource based on the ID corresponding to the cell #1. In some embodiments, the ID corresponding to the cell #1 is a CIF corresponding to the cell #2.

Case 2-4: The first DCI is transmitted on the cell #2, and the cell #1 is self-scheduled. In this case, the identifier is an ID corresponding to the cell #2 or a specific ID, or n_CI is an ID corresponding to the cell #2 or a specific ID. Therefore, the user determines the control resource based on the ID corresponding to the cell #2 or the specific ID. In some embodiments, the ID corresponding to the cell #2 or the specific ID is 0.

Case 2-5: The first DCI is transmitted on the cell #2, and the cell #2 is scheduled by the cell #1. In this case, the identifier is an ID corresponding to the cell #2, or n_CI is an ID corresponding to the cell #2. Therefore, the user determines the control resource based on the ID corresponding to the cell #2. In some embodiments, the ID corresponding to the cell #2 is a CIF corresponding to the cell #2. In this case, the cell #2 has the control resource that can be used for the first DCI, and a configuration thereof includes at least one of the following:

a DCI format configuration, for example, dci-FormatsSL-r16, where in some embodiments, the DCI format configuration may be set to the first DCI;

a CORESET configuration, for example, a CORESET resource configuration, where in some embodiments, the CORESET may be used for the first DCI; and

a search space configuration, for example, a search space time domain location, where in some embodiments, the search space may be used for the first DCI.

Case 2-6: The first DCI is transmitted on the cell #1 or the cell #2. In this case, the identifier or n_CI is a specific ID. For example, in this case, the specific ID corresponds to an ID when there is only one SL carrier, SL cell, SL carrier group, or SL cell group. In this case, the control resource is determined based on the specific ID. In some embodiments, the specific ID is 0.

In some implementations, the cell #1 is a Pcell, and/or the cell #2 is a Scell. In some implementations, the cell #1 is a Scell, and/or the cell #2 is a Pcell.

Case 3: The user is configured with P Uu cells (for example, P=1, cell #1, or for example, P=2, cell #1 and cell #2) and Q SL carriers, cells, carrier groups, or cell groups (for example, Q=3, an SL carrier 1, an SL carrier 2, and an SL carrier 3).

SL DCI corresponding to an SL carrier, SL cell, SL resource pool, or SL BWP m is sent in a Uu cell n.

In this case, the identifier is an ID corresponding to the Uu cell n or a specific ID, or n_CI is an ID corresponding to the cell n or a specific ID. Therefore, the user determines the control resource based on the ID corresponding to the cell n or the specific ID. In some embodiments, the ID corresponding to the cell n or the specific ID is 0.

In some embodiments, M pieces of first DCI are allowed to be sent/received/detected in N time units.

In some embodiments, sizes of these pieces of first DCI are the same, for example, the sizes are aligned through zero padding or truncation.

It should be noted that in this case, by aligning the sizes of these pieces of first DC and increasing a scheduling opportunity, a plurality of SL CCs can still be scheduled at the same time. This is equivalent to a quantity of detection times defined by each scheduling cell, because SCSs of different SL CCs may be different. In this case, the identifier is an ID corresponding to an SL carrier, cell, carrier group, or cell group scheduled by using the first DCI, for example, an SLCIF. Therefore, the user determines the control resource based on the ID corresponding to the SL carrier, the SL cell, the SL resource pool, or the SL BWP. In some embodiments, the ID corresponding to the SL carrier, the SL cell, the SL resource pool, or the SL BWP is a number of the ID corresponding to the SL carrier, the SL cell, the SL resource pool, or the SL BWP. For example, ID numbers corresponding to M SL carriers, SL cells, SL resource pools, or SL BWPs are identified by using m identifiers whose value range is 0, 1, 2, and . . . M−1. When the ID m corresponding to the SL carrier, the SL cell, the SL resource pool, or the SL BWP is scheduled, the corresponding control resource is determined based on the number m.

Further, it should be noted that the following three cells may belong to different cells, or may belong to a same cell:

a cell corresponding to a DCI size budget size in the present application, where it may be understood that the DCI size budget includes at least one of the following:

a total quantity of different DCI sizes should not exceed X; and

a total quantity of sizes of specific DCI does not exceed Y;

a cell corresponding to the target identifier that is considered when the control resource of the first DCI is being determined, for example, a cell corresponding to a CIF or n_CI; and

a cell corresponding to the second DCI or the third DCI.

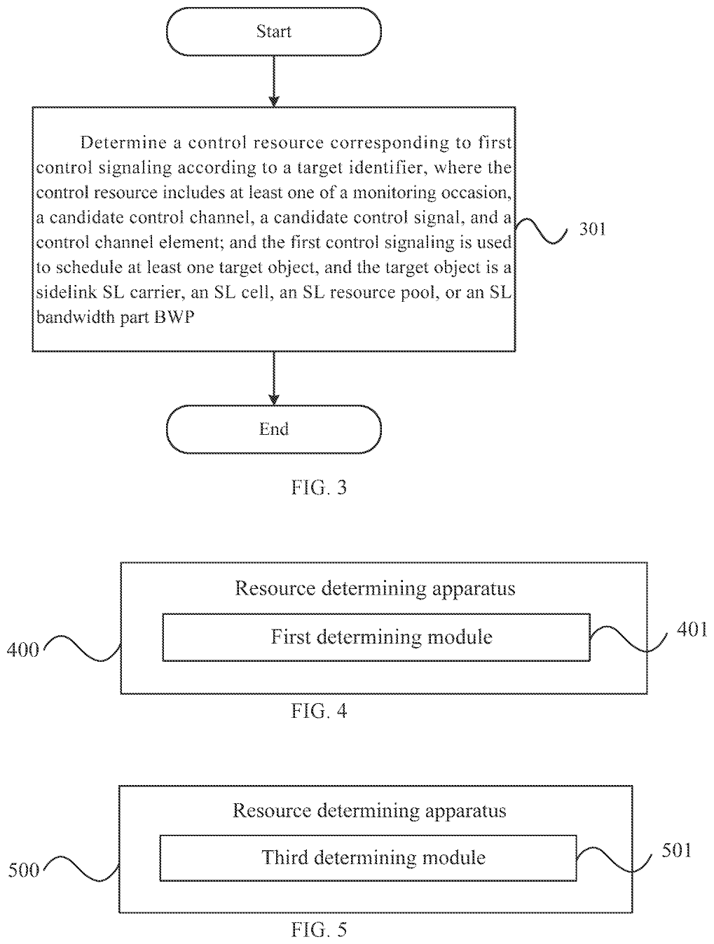

As shown in FIG. 4, an embodiment of this application further provides a resource determining apparatus 400. The apparatus is performed by a terminal and includes:

a first determining module 401, configured to determine a control resource corresponding to first control signaling according to a target identifier, where the control resource includes at least one of a monitoring occasion, a candidate control channel, a candidate control signal, and a control channel element; and

the first control signaling is used to schedule at least one target object, and the target object is a sidelink SL carrier, an SL cell, an SL resource pool, or an SL bandwidth part BWP.

In some embodiments, the target identifier includes at least one of the following:

an identifier associated with the first control signaling; and

an identifier associated with the target object.

In some embodiments, the target identifier includes at least one of the following:

an identifier associated with a configuration of a first target object, where the first target object is one or more of the at least one target object;

an identifier associated with a second target object, where the second target object is one or more of the at least one target object;

an identifier associated with a specific cell in a first cell;

a specific identifier; and

count information associated with the first control signaling.

In some embodiments, the first determining module includes:

a first determining submodule, configured to determine at least one of the following according to the target identifier:

a location of the control resource corresponding to the first control signaling;

a quantity of control resources corresponding to the first control signaling; and

a number of the control resource corresponding to the first control signaling.

In some embodiments, the apparatus further includes:

a processing module, configured to monitor, receive, or blindly detect the first control signaling on the determined control resource.

In some embodiments, the specific cell in the first cell is any one of the following:

a scheduling cell corresponding to the first control signaling;

a scheduling cell corresponding to the target object;

a scheduled cell corresponding to the first control signaling; and

a scheduled cell corresponding to the target object.

In some embodiments, the specific cell in the first cell includes at least one of the following:

a first cell in which the first control signaling is located;

a first cell corresponding to a downlink control information DCI size budget associated with the first control signaling;

a first cell corresponding to a DCI size budget associated with second control signaling, where the second control signaling is Uu control signaling whose size is closest to that of the first control signaling in Uu control signaling that is greater than the first control signaling;

a first cell scheduled by using the second control signaling;

a first cell in which the second control signaling is located;

a first cell corresponding to a DCI size budget associated with third control signaling, where a size of the first control signaling is equal to or aligned with a size of the third control signaling;

a first cell scheduled by using the third control signaling;

a first cell in which the third control signaling is located;

a primary cell;

a primary secondary cell;

a secondary cell;

a first cell that overlaps at least a part of the target object in frequency domain;

a first cell corresponding to a largest identifier in serving cells of the terminal; and

a first cell corresponding to a smallest identifier in the serving cells of the terminal.

In some embodiments, the identifier corresponding to the second target object includes at least one of the following:

a number corresponding to the second target object;

an SL carrier indicator field corresponding to the second target object;

a target parameter corresponding to the second target object;

an identifier corresponding to an uplink carrier or a downlink carrier associated with the second target object;

an identifier corresponding to an uplink BWP or a downlink BWP associated with the second target object; and

an SL BWP identifier corresponding to the second target object.

In some embodiments, the identifier corresponding to the specific cell in the first cell includes at least one of the following:

a number corresponding to the specific cell in the first cell;

a scheduling cell identifier corresponding to the specific cell in the first cell;

a scheduled cell identifier corresponding to the specific cell in the first cell;

a carrier indicator field corresponding to the specific cell in the first cell;

a target parameter corresponding to the specific cell in the first cell;

an identifier corresponding to an uplink carrier or a downlink carrier of the specific cell in the first cell; and

an identifier corresponding to an uplink BWP or a downlink BWP of the specific cell in the first cell.

In some embodiments, the apparatus further includes:

in a case that a first condition is met, the target identifier is a specific identifier.

In some embodiments, the apparatus further includes:

in a case that a first condition is met, the identifier associated with the specific cell in the first cell is a specific identifier.

In some embodiments, the first condition includes at least one of the following:

the terminal is configured with N1 first cells, where N1 is a natural number,

the terminal is configured with N2 first cells in which the first control signaling needs to be monitored, received, or blindly detected, where N2 is a natural number;

the terminal is configured with N3 target objects, where N3 is a natural number;

a target object is in a specific frequency domain;

the specific cell in the first cell has no corresponding identifier;

the specific cell in the first cell supports self-scheduling;

the specific cell in the first cell has a control resource;

the specific cell in the first cell has a control resource associated with the first control signaling;

the specific cell in the first cell is a primary cell;

the specific cell in the first cell is a primary secondary cell;

the specific cell in the first cell is a cell in which a feedback resource is located;

the specific cell in the first cell has no downlink resource;

the specific cell in the first cell is not configured with or does not support cross-carrier scheduling; and

the specific cell in the first cell is configured with or supports cross-carrier scheduling and a scheduling cell is the specific cell itself.

In some embodiments, the apparatus further includes:

a second determining module, configured to determine the target identifier according to a network configuration, a preconfiguration, an indication of another terminal, or a protocol agreement; or

configured to determine the target identifier by the terminal.

In some embodiments, the first control signaling carries the target identifier.

In some embodiments, the first determining module includes:

a second determining submodule, configured to determine the control resource corresponding to the first control signaling according to a correspondence between the target identifier and the control resource.

In some embodiments, the control resource corresponding to the first control signaling includes a set of control resources corresponding to all target objects.

In some embodiments, all target objects scheduled by using the first control signaling share a same control resource.

In some embodiments, when the first control signaling is monitored, received, or blindly detected on the determined control resource, at least one of the following is met:

a quantity of pieces of first control signaling monitored, received, or blindly detected on the control resource within N4 time units does not exceed M1; and

a quantity of pieces of first control signaling decoded by the terminal on the control resource within N5 time units does not exceed M2, where

N4, N5, M1, and M2 are respectively integers greater than or equal to 1.

In some embodiments, the first control signaling meets at least one of the following:

in a case that M1 is greater than 1, M1 pieces of first control signaling have a same size; and

in a case that M2 is greater than 1, M2 pieces of first control signaling have a same size.

In some embodiments,

M1 is a sum of a maximum or minimum quantity of pieces of control signaling corresponding to target objects that are of different SL subcarrier spacings and that are scheduled by a same cell; and/or

M2 is a sum of a maximum or minimum quantity of pieces of control signaling of DCI corresponding to target objects that are of different SL subcarrier spacings and that are scheduled by a same cell.

In some embodiments, if a first cell in which the first control signaling is monitored, received, or configured can be scheduled by another cell, a DCI format supported by the first cell is one of the following:

a first DCI format;

a combination set of a DCI format of a cell scheduling the first cell and the first DCI format; and

an intersection set of the DCI format of the cell scheduling the first cell and the first DCI format.

In some embodiments, if a first cell in which the first control signaling is monitored, received, or configured can be scheduled by another cell, a configuration of the first cell includes a control resource configuration, and the control resource configuration includes at least one of the following:

a DCI format configuration;

a control resource set configuration; and

a search space configuration.

In some embodiments, the first cell is a cell in which there is at least one of uplink transmission and downlink transmission.

In some embodiments, a DCI format supported by the at least one target object scheduled by using the first control signaling is any one of the following:

a first DCI format;

a combination set of a DCI format supported by a cell scheduling the target object and the first DC format; and

an intersection set of the DCI format supported by the cell scheduling the target object and the first DCI format.

In some embodiments, a configuration of the at least one target object scheduled by using the first control signaling includes a DCI format configuration.

In some embodiments, a time unit corresponding to the first control signaling is different from a time unit corresponding to fourth control signaling; or a time interval between the first control signaling and fourth control signaling is greater than or equal to L time units, where L is an integer greater than or equal to 1.

In some embodiments, the fourth control signaling includes at least one of the following:

Uu control signaling; and

SL control signaling for scheduling a target object different from the target object scheduled by using the first control signaling.

In some embodiments, the Uu control signaling includes at least one of the following:

Uu control signaling for scheduling a first target cell, where the first target cell is a cell in which the first control signaling is located; and

Uu control signaling for scheduling a second target cell, where the second target cell is a cell other than the first target cell.

In conclusion, in some embodiments of this application, for SL DCI that is used to schedule an SL carrier, an SL cell, an SL resource pool, an SL BWP, an SL carrier group, an SL cell group, an SL resource pool group, or an SL BWP group, a control resource of the SL DCI is determined by using a target identifier, thereby implementing determining of the control resource of the SL DCI.

It should be noted that the resource determining apparatus provided in some embodiments of this application is an apparatus that can perform the foregoing resource determining method. Therefore, all embodiments of the foregoing resource determining method are applicable to the apparatus, and a same or similar effect can be achieved.

As shown in FIG. 5, an embodiment of this application further provides a resource determining apparatus 500. The apparatus is performed by a network side device and includes:

a third determining module 501, configured to determine a control resource corresponding to first control signaling according to a target identifier, where the control resource includes at least one of a monitoring occasion, a candidate control channel, a candidate control signal, and a control channel element; and

the first control signaling is used to schedule at least one target object, and the target object is a sidelink SL carrier, an SL cell, an SL resource pool, or an SL bandwidth part BWP.

In some embodiments, the target identifier includes at least one of the following:

an identifier associated with the first control signaling; and

an identifier associated with the target object.

In some embodiments, the target identifier includes at least one of the following:

an identifier associated with a configuration of a first target object, where the first target object is one or more of the at least one target object;

an identifier associated with a second target object, where the second target object is one or more of the at least one target object;

an identifier associated with a specific cell in a first cell;

a specific identifier; and

count information associated with the first control signaling.

In some embodiments, the third determining module includes:

a third determining submodule, configured to determine at least one of the following according to the target identifier:

a location of the control resource corresponding to the first control signaling;

a quantity of control resources corresponding to the first control signaling; and

a number of the control resource corresponding to the first control signaling.

In some embodiments, the apparatus further includes:

a sending module, configured to send the first control signaling on the determined control resource.

In some embodiments, the specific cell in the first cell is any one of the following:

a scheduling cell corresponding to the first control signaling;

a scheduling cell corresponding to the target object;

a scheduled cell corresponding to the first control signaling; and

a scheduled cell corresponding to the target object.

In some embodiments, the specific cell in the first cell includes at least one of the following:

a first cell in which the first control signaling is sent;

a first cell corresponding to a DCI size budget associated with the first control signaling;

a first cell corresponding to a DCI size budget associated with second control signaling, where the second control signaling is Uu control signaling whose size is closest to that of the first control signaling in Uu control signaling that is greater than the first control signaling;

a first cell scheduled by using the second control signaling;

a first cell in which the second control signaling is sent;

a first cell corresponding to a DCI size budget associated with third control signaling, where a size of the first control signaling is equal to or aligned with a size of the third control signaling;

a first cell scheduled by using the third control signaling;

a first cell in which the third control signaling is sent;

a primary cell;

a primary secondary cell;

a secondary cell;

a first cell that overlaps at least a part of the target object in frequency domain;

a first cell corresponding to a largest identifier in serving cells of the terminal; and

a first cell corresponding to a smallest identifier in the serving cells of the terminal.

In some embodiments, the identifier corresponding to the second target object includes at least one of the following:

a number corresponding to the second target object;

an SL carrier indicator field corresponding to the second target object;

a target parameter corresponding to the second target object;

an identifier corresponding to an uplink carrier or a downlink carrier associated with the second target object;

an identifier corresponding to an uplink BWP or a downlink BWP associated with the second target object; and

an SL BWP identifier corresponding to the second target object.

In some embodiments, the identifier corresponding to the specific cell in the first cell includes at least one of the following:

a number corresponding to the specific cell in the first cell;

a scheduling cell identifier corresponding to the specific cell in the first cell;

a scheduled cell identifier corresponding to the specific cell in the first cell;

a carrier indicator field corresponding to the specific cell in the first cell;

a target parameter corresponding to the specific cell in the first cell;

an identifier corresponding to an uplink carrier or a downlink carrier of the specific cell in the first cell; and

an identifier corresponding to an uplink BWP or a downlink BWP of the specific cell in the first cell.

In some embodiments, the apparatus further includes:

in a case that a first condition is met, the target identifier is a specific identifier.

In some embodiments, the apparatus further includes:

in a case that a first condition is met, the identifier associated with the specific cell in the first cell is a specific identifier.

In some embodiments, the first condition includes at least one of the following:

a terminal is configured with N1 first cells, where N1 is a natural number,

the terminal is configured with N2 first cells in which the first control signaling needs to be monitored, received, or blindly detected, where N2 is a natural number;

the terminal is configured with N3 target objects, where N3 is a natural number;

a target object is in a specific frequency domain;

the specific cell in the first cell has no corresponding identifier;

the specific cell in the first cell supports self-scheduling;

the specific cell in the first cell has a control resource;

the specific cell in the first cell has a control resource associated with the first control signaling;

the specific cell in the first cell is a primary cell;

the specific cell in the first cell is a primary secondary cell;

the specific cell in the first cell is a cell in which a feedback resource is located;

the specific cell in the first cell has no downlink resource;

the specific cell in the first cell is not configured with or does not support cross-carrier scheduling; and

the specific cell in the first cell is configured with or supports cross-carrier scheduling and a scheduling cell is the specific cell itself.

In some embodiments, the apparatus further includes:

a fourth determining module, configured to determine the target identifier according to a configuration, a preconfiguration, or a protocol agreement, or by the network side device.

In some embodiments, the first control signaling carries the target identifier.

In some embodiments, the third determining module includes:

a fourth determining submodule, configured to determine the control resource corresponding to the first control signaling according to a correspondence between the target identifier and the control resource.

In some embodiments, the control resource corresponding to the first control signaling includes:

a set of control resources corresponding to all target objects.

In some embodiments, all target objects scheduled by using the first control signaling share a same control resource.

In some embodiments, when the first control signaling is sent on the determined control resource,

a quantity of pieces of first control signaling sent on the control resource within N6 time units does not exceed M3, where

N6 and M3 are respectively integers greater than or equal to 1.

In some embodiments, in a case that M3 is greater than 1, M3 pieces of first control signaling have a same size.

In some embodiments, M3 is a sum of a maximum or minimum quantity of pieces of control signaling corresponding to target objects that are of different SL subcarrier spacings and that are scheduled by a same cell.

In some embodiments, if a first cell in which the first control signaling is monitored, received, or configured can be scheduled by another cell, a DCI format supported by the first cell is one of the following:

a first DCI format;

a combination set of a DCI format of a cell scheduling the first cell and the first DC format; and

an intersection set of the DCI format of the cell scheduling the first cell and the first DCI format.

In some embodiments, if a first cell in which the first control signaling is monitored, received, or configured can be scheduled by another cell, a configuration of the first cell includes a control resource configuration, and the control resource configuration includes at least one of the following:

a DCI format configuration;

a control resource set configuration; and

a search space configuration.

In some embodiments, the first cell is a cell in which there is at least one of uplink transmission and downlink transmission.

In some embodiments, a DCI format supported by the at least one target object scheduled by using the first control signaling is any one of the following:

a first DC format;

a combination set of a DCI format supported by a cell scheduling the target object and the first DCI format; and

an intersection set of the DCI format supported by the cell scheduling the target object and the first DCI format.

In some embodiments, a configuration of the at least one target object scheduled by using the first control signaling includes a DCI format configuration.

In some embodiments, a time unit corresponding to the first control signaling is different from a time unit corresponding to fourth control signaling; or a time interval between the first control signaling and fourth control signaling is greater than or equal to L time units, where L is an integer greater than or equal to 1.

In some embodiments, the fourth control signaling includes at least one of the following:

Uu control signaling; and

SL control signaling for scheduling a target object different from the target object scheduled by using the first control signaling.

In some embodiments, the Uu control signaling includes at least one of the following:

Uu control signaling for scheduling a first target cell, where the first target cell is a cell in which the first control signaling is located; and

Uu control signaling for scheduling a second target cell, where the second target cell is a cell other than the first target cell.

In conclusion, in some embodiments of this application, for SL DCI that is used to schedule an SL carrier, an SL cell, an SL resource pool, an SL BWP, an SL carrier group, an SL cell group, an SL resource pool group, or an SL BWP group, a control resource of the SL DCI is determined by using a target identifier, thereby implementing determining of the control resource of the SL DCI.

It should be noted that the resource determining apparatus provided in some embodiments of this application is an apparatus that can perform the foregoing resource determining method. Therefore, all embodiments of the foregoing resource determining method are applicable to the apparatus, and a same or similar effect can be achieved.

The resource determining apparatus in some embodiments of this application may be an apparatus, or may be a component, an integrated circuit, or a chip in a terminal. The apparatus may be a mobile electronic device, or may be a non-mobile electronic device. For example, the mobile electronic device may be a mobile phone, a tablet computer, a laptop computer, a palmtop computer, an in-vehicle electronic terminal, a wearable device, an ultra-mobile personal computer (UMPC), a netbook, or a personal digital assistant (PDA). The non-mobile electronic device may be a server, a network attached storage (NAS), a personal computer (PC), a television (TV), an automated teller machine, or a self-service machine. This is not specifically limited in some embodiments of this application.

The resource determining apparatus in some embodiments of this application may be an apparatus with an operating system. The operating system may be an Android operating system, an iOS operating system, or another possible operating system. This is not specifically limited in the embodiments of this application.

The resource determining apparatus provided in some embodiments of this application can implement the processes implemented in the method embodiments in FIG. 1 to FIG. 3. To avoid repetition, details are not described herein again.

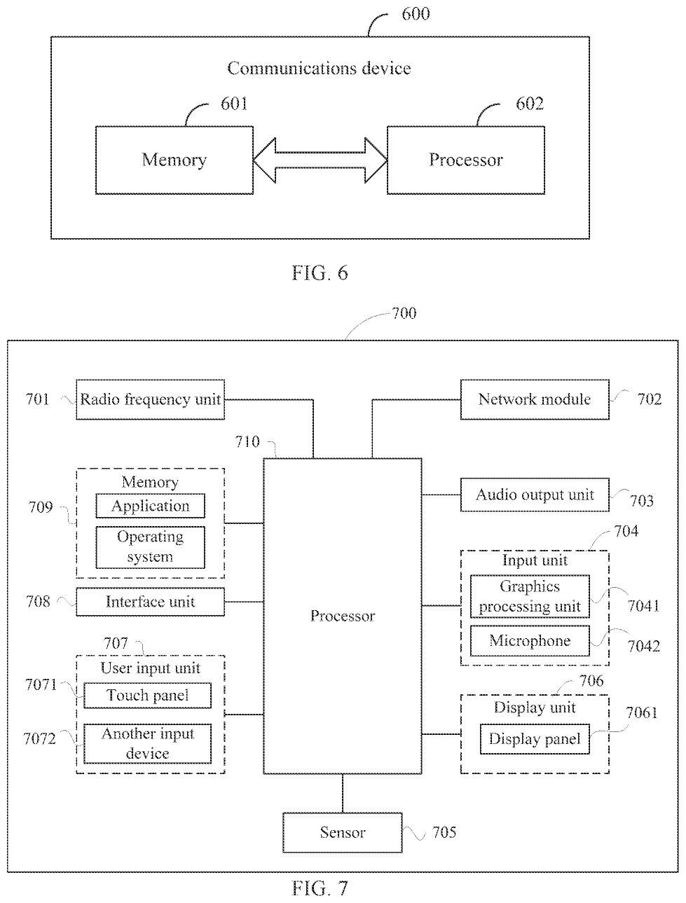

As shown in FIG. 6, some embodiments of this application further provides a communications device 600, including a processor 601, a memory 602, and a program or an instruction that is stored in the memory 602 and that can be run on the processor 601. For example, when the communications device 600 is a terminal, the program or the instruction is executed by the processor 601 to implement the processes of the foregoing resource determining method embodiment, and a same technical effect can be achieved. When the communications device 600 is a network side device, the program or the instruction is executed by the processor 601 to implement the processes of the foregoing resource determining method embodiment, and a same technical effect can be achieved. To avoid repetition, details are not described herein again.

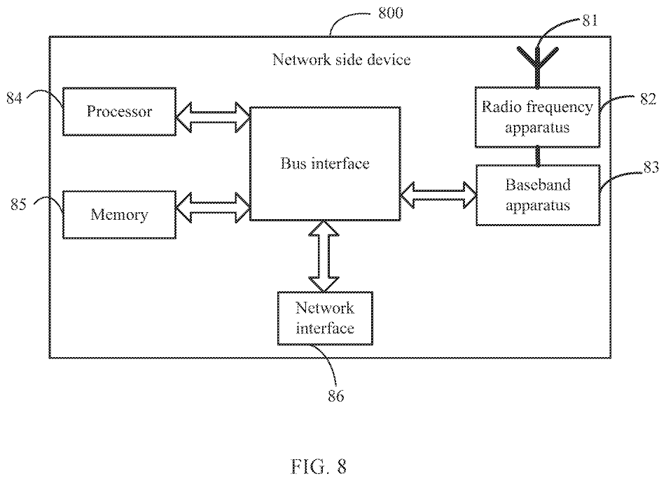

FIG. 7 is a schematic structural diagram of hardware of a terminal according to an embodiment of this application. A terminal 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in some embodiments of this application, the input unit 704 may include a graphics processing unit (GPU) 7041 and a microphone 7042, and the graphics processing unit 7041 processes image data of a still picture or a video obtained by an image capture apparatus (such as a camera) in a video capture mode or an image capture mode. The display unit 706 may include a display panel 7061. In some embodiments, the display panel 7061 may be configured in a form such as a liquid crystal display or an organic light-emitting diode. The user input unit 707 includes a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In some embodiments of this application, the radio frequency unit 701 receives downlink data from a network side device and then sends the downlink data to the processor 710 for processing; and sends uplink data to the network side device. Usually, the radio frequency unit 701 includes but is not limited to an antenna, at least one amplifier, a transceiver, a coupler, a low noise amplifier, a duplexer, and the like.

The memory 709 may be configured to store a software program or an instruction and various data. The memory 709 may mainly include a program or instruction storage area and a data storage area. The program or instruction storage area may store an operating system, and an application or an instruction required by at least one function (for example, a sound playing function or an image playing function). In addition, the memory 709 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory. For example, at least one disk storage component, a flash memory component, or another non-volatile solid-state storage component.

The processor 710 may include one or more processing units. In some embodiments, an application processor and a modem processor may be integrated into the processor 710. The application processor mainly processes an operating system, a user interface, an application, an instruction, or the like. The modem processor mainly processes wireless communications, for example, a baseband processor. It can be understood that, the modem processor may not be integrated into the processor 710.

This processor 710 is configured to determine a control resource corresponding to first control signaling according to a target identifier, where the control resource includes at least one of a monitoring occasion, a candidate control channel, a candidate control signal, and a control channel element; and the first control signaling is used to schedule at least one target object, and the target object is a sidelink SL carrier, an SL cell, an SL resource pool, or an SL bandwidth part BWP.

In conclusion, in some embodiments of this application, for SL DCI that is used to schedule an SL carrier, an SL cell, an SL resource pool, an SL BWP, an SL carrier group, an SL cell group, an SL resource pool group, or an SL BWP group, a control resource of the SL DCI is determined by using a target identifier, thereby implementing determining of the control resource of the SL DCI.

It should be noted that the resource determining apparatus provided in some embodiments of this application is an apparatus that can perform the foregoing resource determining method. Therefore, all embodiments of the foregoing resource determining method are applicable to the apparatus, and a same or similar effect can be achieved.

In some embodiments of this application further provides a network side device. As shown in FIG. 8, a network device 800 includes an antenna 81, a radio frequency apparatus 82, and a baseband apparatus 83. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

The band processing apparatus may be located in the baseband apparatus 83. The method performed by the network side device in the foregoing embodiment may be implemented in the baseband apparatus 83. The baseband apparatus 83 includes a processor 84 and a memory 85.

The baseband apparatus 83 may include, for example, at least one baseband board, where a plurality of chips are disposed on the baseband board. As shown in FIG. 8, one chip is, for example, the processor 84, which is connected to the memory 85, so as to invoke a program in the memory 85 to perform operations of the network device shown in the foregoing method embodiment.

The baseband apparatus 83 may further include a network interface 86, configured to exchange information with the radio frequency apparatus 82. For example, the interface is a common public radio interface (CPRI).

In some embodiments, the network side device in some embodiments of the present application further includes an instruction or a program that is stored in the memory 85 and that can be run on the processor 84. The processor 84 invokes the instruction or the program in the memory 85 to perform the method performed by the modules shown in FIG. 8, and a same technical effect is achieved. To avoid repetition, details are not described herein again.

An embodiment of this application further provides a readable storage medium. The readable storage medium stores a program or an instruction, and when the program or the instruction is executed by a processor, the processes of the foregoing resource determining method embodiment are implemented and a same technical effect can be achieved. To avoid repetition, details are not described herein again.

The processor is a processor in the electronic device in the foregoing embodiment. The readable storage medium includes a computer-readable storage medium, such as a computer ROM, a Random Access Memory (RAM), a magnetic disk, or an optical disc.

An embodiment of this application further provides a chip. The chip includes a processor and a communications interface, the communications interface is coupled to the processor, and the processor is configured to run a program or an instruction to implement the processes of the foregoing resource determining method embodiment, and a same technical effect can be achieved. To avoid repetition, details are not described herein again.

It should be understood that the chip mentioned in some embodiments of this application may also be referred to as a system-level chip, a system chip, a chip system, or an on-chip system chip.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, a network device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A resource determining method, performed by a terminal, comprising:
determining a control resource corresponding to first control signaling according to a target identifier, wherein:
the control resource comprises at least one of a monitoring occasion, a candidate control channel, a candidate control signal, or a control channel element; and
the first control signaling is used to schedule at least one target object, and the target object is a sidelink (SL) carrier, an SL cell, an SL resource pool, or an SL bandwidth part (BWP).

2. The resource determining method according to claim 1, wherein the target identifier comprises at least one of the following:
an identifier associated with the first control signaling; or
an identifier associated with the target object.

3. The resource determining method according to claim 1, wherein the target identifier comprises at least one of the following:
an identifier associated with a configuration of a first target object, wherein the first target object is one or more of the at least one target object;
an identifier associated with a second target object, wherein the second target object is one or more of the at least one target object;
an identifier associated with a specific cell in a first cell;
a specific identifier, wherein the specific identifier is 0, 1010, 510, 1100, 501, or 1008; or
count information associated with the first control signaling.

4. The resource determining method according to claim 1, wherein the determining a control resource corresponding to first control signaling according to a target identifier comprises:
determining at least one of the following according to the target identifier:
a location of the control resource corresponding to the first control signaling;
a quantity of control resources corresponding to the first control signaling; or
a number of the control resource corresponding to the first control signaling.

5. The resource determining method according to claim 1, further comprising:
monitoring, receiving, or blindly detecting the first control signaling on the determined control resource.

6. The resource determining method according to claim 1, wherein a DCI format supported by the at least one target object scheduled by using the first control signaling is any one of the following:
a first DCI format;
a combination set of a DCI format supported by a cell scheduling the target object and the first DCI format; or
an intersection set of the DCI format supported by the cell scheduling the target object and the first DCI format.

7. The resource determining method according to claim 6, wherein the first control signaling is a first DCI, the first DCI is sidelink downlink control information (SL DCI), and the first DCI covers a DCI format configuration comprised in a search space configuration of a Uu cell scheduling the target object.

8. The resource determining method according to claim 6, wherein the first control signaling is a first DCI, the first DCI is sidelink downlink control information (SL DCI), and the terminal ignores a DCI format configuration comprised in a search space configuration of a Uu cell scheduling the target object.

9. The resource determining method according to claim 1, wherein a configuration of the at least one target object scheduled by using the first control signaling comprises a DCI format configuration.

10. A resource determining method, performed by a network side device, comprising:
determining a control resource corresponding to first control signaling according to a target identifier, wherein:
the control resource comprises at least one of a monitoring occasion, a candidate control channel, a candidate control signal, or a control channel element; and
the first control signaling is used to schedule at least one target object, and the target object is a sidelink (SL) carrier, an SL cell, an SL resource pool, or an SL bandwidth part (BWP).

11. The resource determining method according to claim 10, wherein the target identifier comprises at least one of the following:
an identifier associated with the first control signaling; or
an identifier associated with the target object.

12. The resource determining method according to claim 10, wherein the target identifier comprises at least one of the following:
an identifier associated with a configuration of a first target object, wherein the first target object is one or more of the at least one target object;
an identifier associated with a second target object, wherein the second target object is one or more of the at least one target object;
an identifier associated with a specific cell in a first cell;
a specific identifier, wherein the specific identifier is 0, 1010, 510, 1100, 501, or 1008; or
count information associated with the first control signaling.

13. The resource determining method according to claim 10, wherein the determining a control resource corresponding to first control signaling according to a target identifier comprises:
determining at least one of the following according to the target identifier:
a location of the control resource corresponding to the first control signaling;
a quantity of control resources corresponding to the first control signaling; or
a number of the control resource corresponding to the first control signaling.

14. The resource determining method according to claim 10, further comprising:
sending the first control signaling on the determined control resource.

15. The resource determining method according to claim 12, wherein the specific cell in the first cell is any one of the following:
a scheduling cell corresponding to the first control signaling;
a scheduling cell corresponding to the target object;
a scheduled cell corresponding to the first control signaling; or
a scheduled cell corresponding to the target object.

16. The resource determining method according to claim 10, further comprising:
determining the target identifier according to a configuration, a preconfiguration, or a protocol agreement, or by the network side device.

17. The resource determining method according to claim 10, wherein the control resource corresponding to the first control signaling comprises:
a set of control resources corresponding to all target objects.

18. The resource determining method according to claim 10, wherein a DCI format supported by the at least one target object scheduled by using the first control signaling is any one of the following:
a first DCI format;
a combination set of a DCI format supported by a cell scheduling the target object and the first DCI format; or
an intersection set of the DCI format supported by the cell scheduling the target object and the first DCI format.

19. A terminal, comprising:
a memory storing a computer program; and
a processor coupled to the memory and configured to execute the computer program to perform operations comprising:
determining a control resource corresponding to first control signaling according to a target identifier, wherein:
the control resource comprises at least one of a monitoring occasion, a candidate control channel, a candidate control signal, or a control channel element; and
the first control signaling is used to schedule at least one target object, and the target object is a sidelink (SL) carrier, an SL cell, an SL resource pool, or an SL bandwidth part (BWP).

20. The terminal according to claim 19, wherein the target identifier comprises at least one of the following:
an identifier associated with the first control signaling; or
an identifier associated with the target object.
